(19) United States
(12) Patent Application Publication
(10) Pub. No.: US 2016/0269773 A1
(43) Pub. Date: Sep. 15, 2016

(54) VIDEO IMAGE RECEIVING APPARATUS AND VIDEO IMAGE RECEIVING METHOD

(71) Applicant: Panasonic Intellectual Property Management Co., Ltd., Osaka (JP)

(72) Inventor: KASAI ONO, Tokyo (JP)

(21) Appl. No.: 14/932,945

(22) Filed: Nov. 4, 2015

(30) Foreign Application Priority Data
Mar. 12, 2015 (JP) 2015-049532

(51) Int. Cl. H04N 21/431; H04N 21/2543

(52) U.S. Cl. CPC H04N 21/4312; H04N 21/2543

(57) ABSTRACT

A video image receiving apparatus includes a controller which outputs to a video image of a selection service for allowing selection of one service from a plurality of services including a plurality of first services and a plurality of second services. The video image of the selection service includes a plurality of first display regions, a plurality of second display regions and a cursor video image. The controller displays a corresponding first reduced video image in a first display region pointed by the cursor, and displays an icon video image for hiding a reduced video image in each of the other display regions when the cursor points to one of first display regions. The controller displays a corresponding second reduced video image in each of second display regions and displays an icon video image in each of first display regions when the cursor points to one of second display regions.

### BACKGROUND OF THE INVENTION

1. Field of the Invention

The present disclosure relates to a video image receiving apparatus and a video image receiving method which display a selection service for allowing selection of one service from a plurality of services.

2. Description of the Related Art

Unexamined Japanese Patent Publication No. 2012-209829 discloses a program display control apparatus which, when a number of available programs of a cable television or the like (a number of services) is large, displays a list of icon video images (thumbnail images) of the available programs and detailed information of the icon video images. This program display control apparatus displays a program list matching classification conditions specified by a user. Further, in the program list, thumbnail images of programs are displayed.

### SUMMARY OF THE INVENTION

A video image receiving apparatus according to the present disclosure includes a video processor which outputs to a video image displaying apparatus a video image of a selection service for allowing selection of one service from a plurality of services including a plurality of first services and a plurality of second services. The video image of the selection service includes: a plurality of first display regions where a plurality of first reduced video images are displayed, the first reduced video images being obtained by reducing video images of the plurality of first services; a plurality of second display regions where a plurality of second reduced video images are displayed, the second reduced video images being obtained by reducing video images of the plurality of second services; and a cursor which points to one display region of the plurality of first display regions and the plurality of second display regions. The video processor outputs to the video image displaying apparatus, when the cursor points to one of the plurality of first display regions, a video image of a first selection service which displays a first reduced video image corresponding to a first display region pointed by the cursor in the first display region, and displays an icon video image for hiding the first reduced video image or the second reduced video image in each of other first display regions except for the first display region and the plurality of second display regions. The video processor outputs to the video image displaying apparatus, when the cursor points to one of the plurality of second display regions, a video image of a second selection service which displays a second reduced video image corresponding to a second display region in each of the second display regions, and displays the icon video image in each of the plurality of first display regions.

### BRIEF DESCRIPTION OF DRAWINGS

FIG. 1 is a diagram illustrating a relationship between a video image receiving apparatus and a broadcast station, a portal server and a TV according to an exemplary embodiment;

FIG. 2A is a block diagram illustrating an example of a configuration of an STB (Set Top Box) according to the exemplary embodiment;

FIG. 2B is a diagram illustrating an example of specification information according to the exemplary embodiment;

FIG. 3 is a block diagram illustrating an example of a configuration of the broadcast station according to the exemplary embodiment;

FIG. 4A is a block diagram illustrating an example of a configuration of the portal server according to the exemplary embodiment;

FIG. 4B is a diagram illustrating an example of mapping information according to the exemplary embodiment;

FIG. 5 is a diagram illustrating an example of the TV which displays a selection service according to the exemplary embodiment;

FIG. 6 is a flowchart illustrating a process of displaying a selection service according to the exemplary embodiment;

FIG. 7 is a diagram illustrating an example of a template video image according to the exemplary embodiment;

FIG. 8A is a diagram illustrating an example of a reduced video image group according to the exemplary embodiment;

FIG. 8B is a diagram illustrating a relationship between a plurality of reduced video images included in the reduced video image group and application regions of the reduced video images according to the exemplary embodiment;

FIG. 9 is a flowchart illustrating an example of a processing process of a method of obtaining a video image and an audio of a selection service according to the exemplary embodiment;

FIG. 10A is a diagram illustrating an example of a video image of a first selection service according to the exemplary embodiment;

FIG. 10B is a diagram illustrating another example of a video image of a first selection service according to the exemplary embodiment;

FIG. 10C is a diagram illustrating an example of a video image of a second selection service according to the exemplary embodiment;

FIG. 10D is a diagram illustrating another example of a video image of the second selection service according to the exemplary embodiment;

FIG. 11 is a diagram illustrating an example of a video image of a selection service on a first page according to a modified example 1;

FIG. 12A is a diagram illustrating an example of a video image of a selection service on second and subsequent pages according to the modified example 1;

FIG. 12B is a diagram illustrating another example of a video image of a selection service on second and subsequent pages according to the modified example 1;

FIG. 13 is a diagram illustrating an example of a video image of the first selection service obtained after a specification change according to a modified example 2;

FIG. 14 is a diagram illustrating an example of specification information obtained after the specification change according to the modified example 2; and

FIG. 15 is a diagram illustrating an example of a reduced video image group according to another exemplary embodiment.

### DETAILED DESCRIPTION OF THE PREFERRED EMBODIMENTS

### Details of Problem

A method of describing contents of each service by characters such as a conventional EPG (Electronic Program Guide) has a problem that, when a number of available services is large, a user cannot intuitively and easily understand service contents.

By contrast with this, there may be a method of displaying reduced video images of a plurality of services (hereinafter such video images will be also referred to as “reduced video images” as appropriate) on one screen. In the case of a moving image, a user can intuitively understand contents of multiple services all at once.

However, to simultaneously display reduced video images of a plurality of services on one screen, it is necessary to obtain, from one or a plurality of advertisers and video image right holders, permission for each of the plurality of services to simultaneously display, on one screen, reduced video images of services of the advertisers and video image right holders and reduced video images of other services. There is a problem that a reduced video image of a service whose permission cannot be obtained and reduced video images of other services cannot be simultaneously displayed on one screen.

Therefore, the present disclosure provides a video image receiving apparatus and a video image receiving method which, when there are a service which is not permitted to be simultaneously displayed on one screen together with reduced video images of other services, and a service whose permission is obtained in a mixed fashion, can provide a selection service according to the permission.

Exemplary embodiments will be described in detail with reference to the drawings as appropriate. In this regard, an unnecessarily detailed description may not be given. For example, a detailed description of a well-known matter and a redundant description on substantially the same configuration may not be given. This is to prevent the following description from being unnecessarily redundant, so as to facilitate understanding of those skilled in the art.

In addition, the inventor of the present disclosure provides the accompanying drawings and the following description for those skilled in the art to sufficiently understand the present disclosure, and does not intend to limit a subject matter described in the claims by the accompanying drawings and the following description.

### EXEMPLARY EMBODIMENT

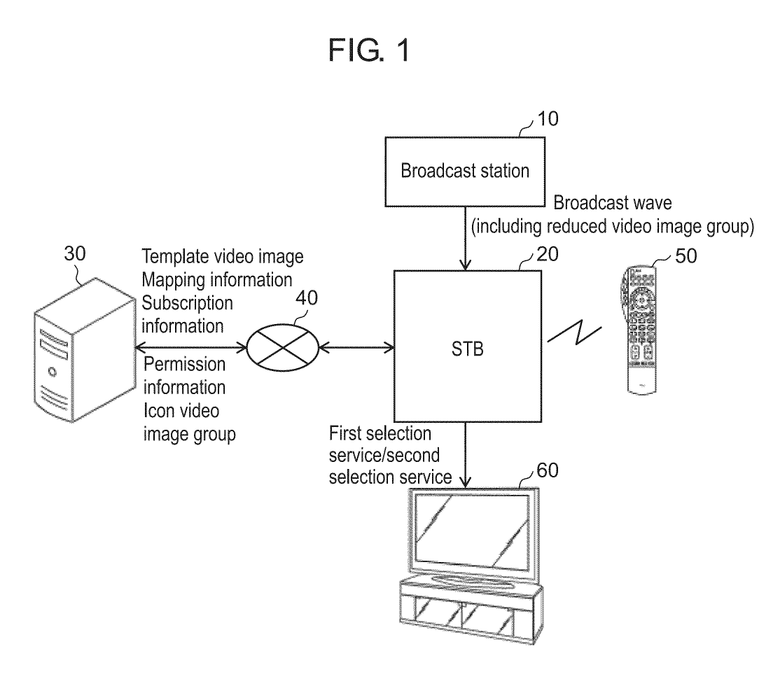

A video image receiving apparatus and a video image receiving method according to the exemplary embodiment will be described below with reference to FIGS. 1 to 10D.

The video image receiving apparatus and the video image receiving method according to the present exemplary embodiment provide a selection service for allowing selection of one service from a plurality of services including a plurality of first services and a plurality of second services. Each first service is a service whose reduced video image is not permitted to be simultaneously displayed on one screen together with reduced video images of other services, and each second service is a service whose reduced video image is permitted to be simultaneously displayed.

The video image receiving apparatus and the video image receiving method according to the present exemplary embodiment provide one of a first selection service and a second selection service according to whether a service of selection services pointed by a cursor is the first service or the second service.

When the service pointed by the cursor is the first service, while a reduced video image of the first service (hereinafter abbreviated as a “first reduced video image”) is displayed, the first selection service is provided which does not allow reduced video images of other services to be displayed. When the service pointed by the cursor is the second service, the second selection service is provided which allows the reduced video image(s) of one or a plurality of second services (hereinafter referred to as “second reduced video images”) to be simultaneously displayed on one screen. Consequently, it is possible to provide a selection service according to such permission.

[1. Overall Configuration]

First, configurations of the video image receiving apparatus according to the present exemplary embodiment and peripheral devices of the video image receiving apparatus will be described with reference to FIGS. 1 to 4A. In the present exemplary embodiment, a case where the video image receiving apparatus is an STB (Set Top Box) which receives broadcast waves of cable broadcast will be described as an example.

FIG. 1 is a diagram illustrating an example of a connection configuration of the video image receiving apparatus and the peripheral devices of the video image receiving apparatus. FIG. 1 illustrates STB 20 which is an example of the video image receiving apparatus, and broadcast station 10, portal server 30, remote controller 50, and TV (Television) 60 which are examples of the peripheral devices.

In addition, broadcast waves of cable broadcast include digital terrestrial broadcast and CS (Communication Satellite) broadcast.

In addition, in the following exemplary embodiment, a “video image” refers to a moving image, and does not include a still image unless specified in particular. Further, the “image” refers to a “still image”.

[1-1. Configuration of STB 20 (Video Image Receiving Apparatus)]

STB 20 receives broadcast waves from broadcast station 10, and outputs a video image and an audio of a service to provide to TV 60 according to an operation of remote controller 50 for STB 20. Further, STB 20 is connected to portal server 30 through network 40 such as the Internet or an intranet.

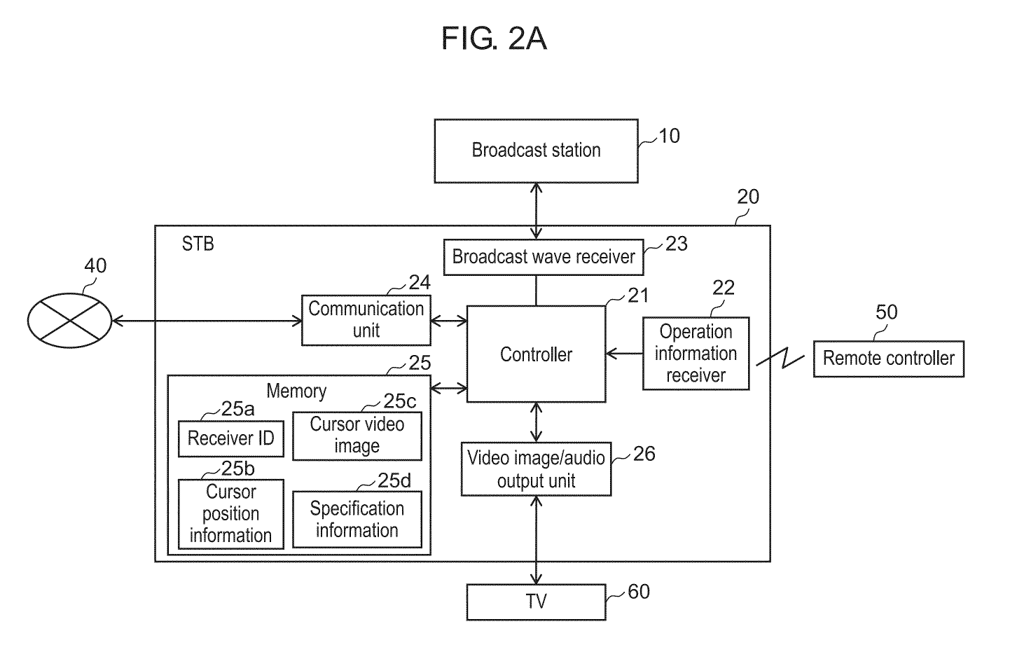

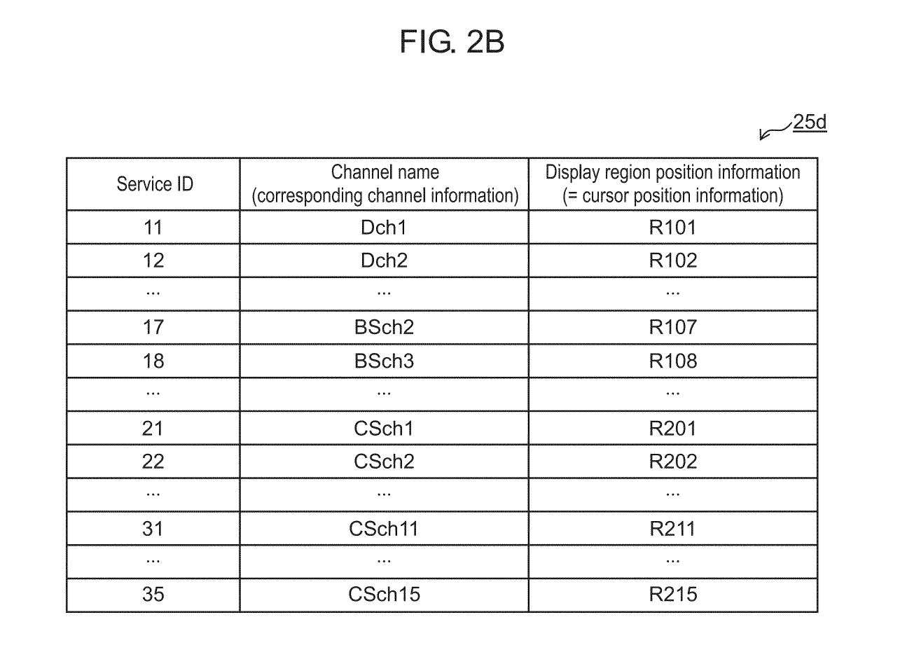

FIG. 2A is a block diagram illustrating an example of a configuration of STB 20. As illustrated in FIG. 2A, STB 20 includes controller 21, operation information receiver 22, broadcast wave receiver 23, communication unit 24, memory 25 and video image/audio output unit 26.

Controller 21 controls each function which composes STB 20. Controller 21 is generally configured as a CPU (Central Processing Unit) or an arithmetic operation processor, and controls each function which composes STB 20 when the CPU executes a control program stored in memory 25.

Controller 21 outputs a video image and an audio of the first service, a video image and an audio of the second service, or a video image of a selection service to TV 60 according to an operation of remote controller 50. When the first service or the second service is selected by the operation of remote controller 50, controller 21 outputs to TV 60 a video image and an audio of a service extracted from a broadcast wave by broadcast wave receiver 23 described below. When a selection service is selected by the operation of remote controller 50, controller 21 generates a video image of the first selection service or a video image of the second selection service to output the generated video images to TV 60.

In addition, controller 21 and video image/audio output unit 26 described below configure a video processor which outputs a video image of a selection service to the video image displaying apparatus. Although described below in detail, a video image of a selection service includes a plurality of first display regions, a plurality of second display regions, and a cursor which points to one of a plurality of first display regions and a plurality of second display regions. In each of the plurality of first display regions, a first reduced video image obtained by reducing a video image of a corresponding first service is displayed. In each of the plurality of second display regions, a second reduced video image obtained by reducing a video image of a corresponding second service is displayed.

Operation information receiver 22 includes an infrared communication unit in the present exemplary embodiment, and receives a signal indicating a pushed key from remote controller 50 described below by way of infrared communication. Operation information receiver 22 outputs information of a key indicated by a received signal, to controller 21.

Broadcast wave receiver 23 is an example of a service receiver which receives a reduced video image group and a multiplexed audio from broadcast station 10 which is an example of an external apparatus. Broadcast wave receiver 23 includes one tuner which decodes a broadcast wave to a video image and an audio of a service instructed by controller 21. What one tuner can extract from a broadcast wave is a video image and an audio of one service. Broadcast wave receiver 23 outputs the extracted video image and audio to controller 21.

Communication unit 24 performs network communication with portal server 30 through network 40.

Memory 25 is configured to include a RAM (Random Access Memory) in which temporary data used for processing of controller 21 is stored, a ROM (Read Only Memory) in which a control program and the like are stored, and a memory element such as a hard disk which is used to record a service. Memory 25 stores receiver ID 25a for specifying STB 20, cursor position information 25b in a selection service, cursor video image 25c which is a cursor video image, and specification information 25d based on which a specification of a selection service is determined. In addition, a case where memory 25 is built in STB 20 will be described in the present exemplary embodiment. However, the present disclosure is not limited to this. Memory 25 may be a memory element such as an externally connected hard disk or may be used in combination with a memory element externally connected with a built-in memory element.

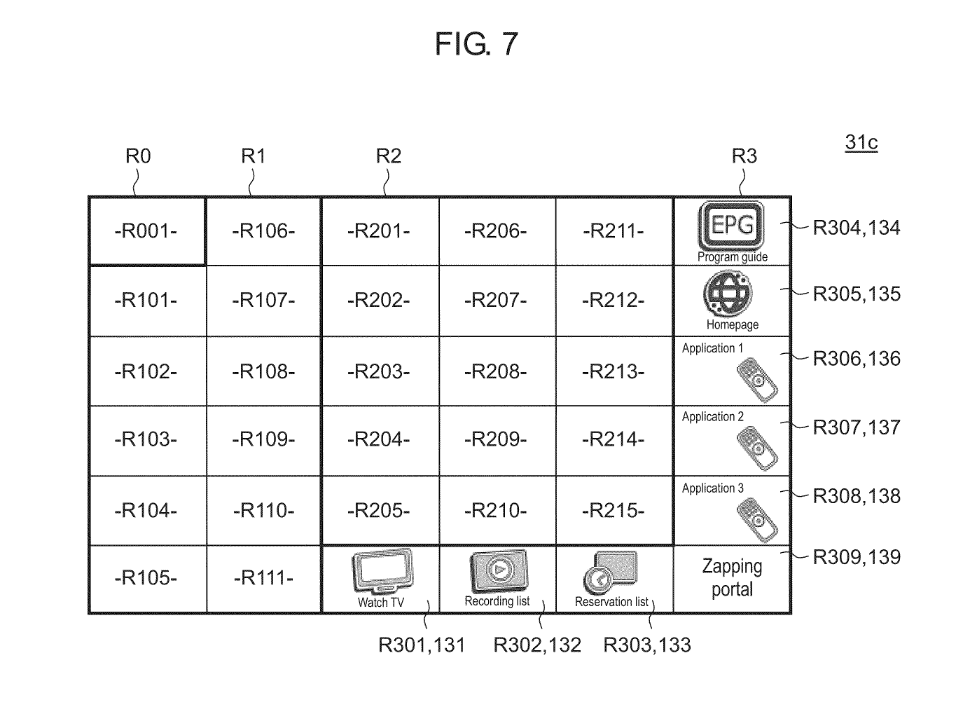

Cursor position information 25b is information indicating one of a plurality of display regions included in a selection service in the present exemplary embodiment. Cursor position information 25b is represented by, for example, display regions R001, R101 to R111 and R201 to R215 in FIG. 7 described below. The cursor is moved one display region by one display region in response to one push of a direction key of remote controller 50 described below. In addition, cursor position information 25b may be coordinates or a movement amount from a reference point. Cursor position information 25b is initialized to a position of an upper left display region of a plurality of display regions when a video image of a selection service starts being displayed. Then, every time remote controller 50 transmits a cursor movement request (a signal indicating that the direction key has been pushed), controller 21 updates cursor position information 25b to a position corresponding to the movement request transmitted from remote controller 50.

Cursor video image 25c is, for example, a figure of a frame shape which encircles a first reduced video image or a second reduced video image. Although described in detail below, in the present exemplary embodiment, the first reduced video image and the second reduced video image are video images of rectangular shapes, and therefore cursor video image 25c is also a rectangular frame. Cursor video image 25c may be stored as an image of a bitmap format or may be indicated by lengths of long sides, lengths of short sides, colors and boldness of lines and the like in the case of the rectangular shape.

Specification information 25d is information which indicates in which display region of a plurality of first display regions and a plurality of second display regions a reduced video image of each service of a plurality of services is displayed, i.e., at which position a reduced video image of each service is displayed in a video image of a selection service.

FIG. 2B is a diagram illustrating an example of specification information 25d according to the present exemplary embodiment. As illustrated in FIG. 2B, specification information 25d includes a service ID uniquely allocated to each service, a channel name of each service, and position information indicating a position of a display region for displaying a reduced video image of each service (hereinafter such position information will be abbreviated as “display region position information” as appropriate). Display region position information corresponds to position information of first display regions R101 to R111 and second display regions R201 to R215 illustrated in FIG. 7 described below. Position information may be a base point (e.g., coordinates at an upper left corner) and lengths (the number of pixels) in a vertical direction and a horizontal direction, or coordinates of two diagonal corners (e.g., coordinates at the upper left corner and coordinates at a lower right corner).

Video image/audio output unit 26 is an interface unit to TV 60, and outputs a video image and an audio to TV 60.

[1-2. Configuration of Broadcast Station]

Broadcast station 10 generates a broadcast wave for transmitting a plurality of first services, a plurality of second services, and a service including a reduced video image group and a multiplexed audio for generating a selection service, and outputs the broadcast wave to STB 20.

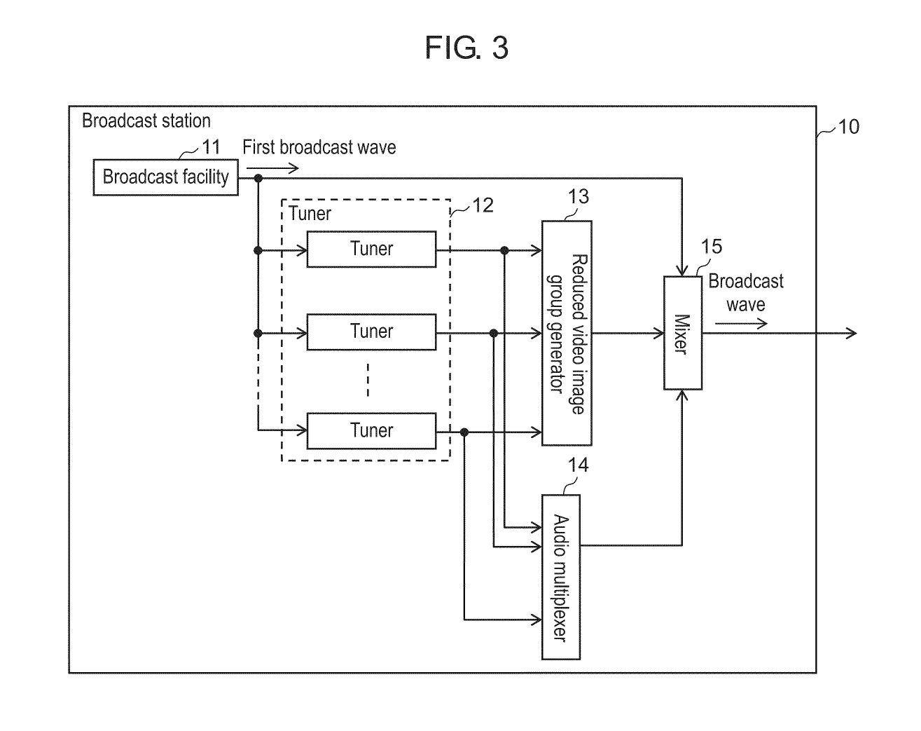

FIG. 3 is a block diagram illustrating an example of a configuration of broadcast station 10 according to the present exemplary embodiment. As illustrated in FIG. 3, broadcast station 10 includes broadcast facility 11, tuner 12, reduced video image group generator 13, audio multiplexer 14, and mixer 15.

Broadcast facility 11 is a facility which generates a first broadcast wave including a plurality of first services and a plurality of second services. In addition, broadcast facility 11 does not need to be configured as one facility.

Tuner 12 includes a plurality of tuners. For example, each of a plurality of tuners decodes a first broadcast wave to a video image and an audio of a corresponding service. In addition, the number of a plurality of tuners included in tuner 12 does not need to be the same as a total number of first services and second services or a number of services used to generate a video image of a selection service.

Reduced video image group generator 13 generates a reduced video image group including a plurality of reduced video images by using video images of a plurality of services output from tuner 12. A reduced video image group will be described below in detail.

Audio multiplexer 14 multiplexes audios of a plurality of services output from a plurality of tuners which composes tuner 12, and generates a multiplexed audio.

Mixer 15 mixes a reduced video image group generated by reduced video image group generator 13 and a multiplexed audio generated by audio multiplexer 14, and generates one service. Further, mixer 15 superimposes the generated service on a first broadcast wave transmitted from broadcast facility 11, and generates a broadcast wave. Mixer 15 transmits the broadcast wave to STB 20.

[1-3. Configuration of Portal Server 30]

Portal server 30 is a server which stores information required to provide a selection service, and outputs, according to an information obtaining request from STB 20, information indicated by the information obtaining request to STB 20. The portal server is configured to communicate with STB 20 through general network 40.

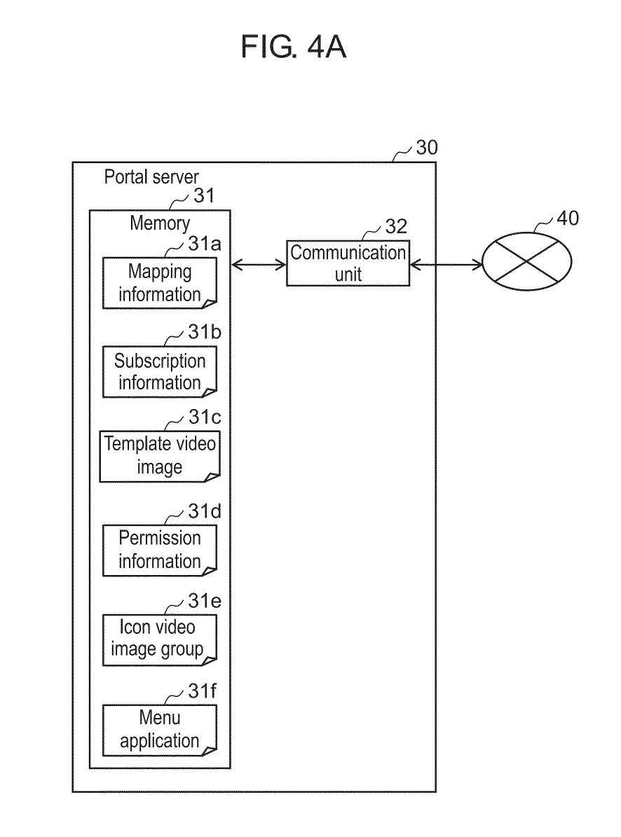

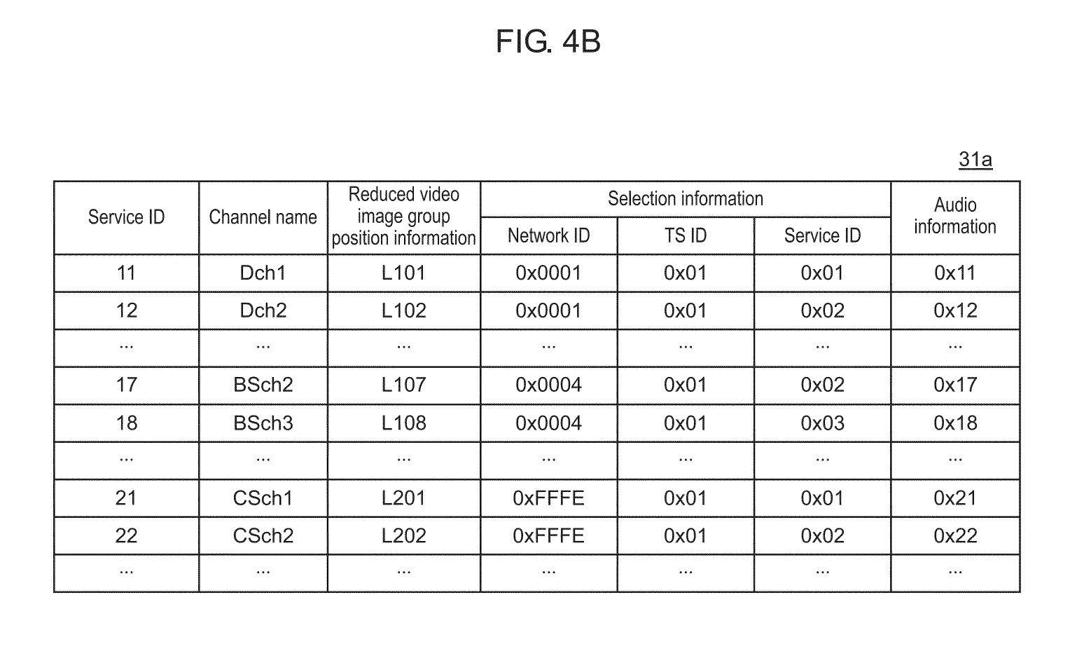

FIG. 4A is a block diagram illustrating an example of a configuration of portal server 30 according to the present exemplary embodiment. As illustrated in FIG. 4A, portal server 30 includes memory 31 and communication unit 32.

Memory 31 includes a RAM, a ROM and a hard disk, and stores mapping information 31a, subscription information 31b, template video image 31c, permission information 31d, icon video image group 31e, and menu application 31f in the present exemplary embodiment.

Mapping information 31a is information indicating a position of a reduced video image of each service (corresponding to a cursor position) in a reduced video image group per each of a plurality of services.

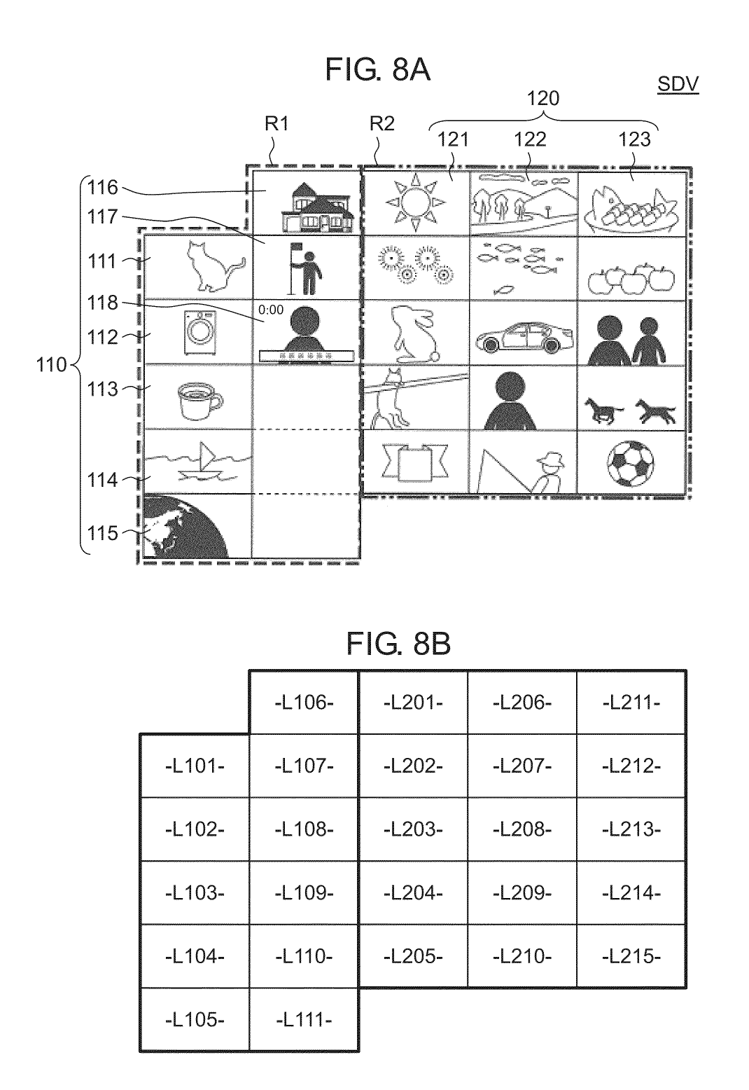

FIG. 4B is a diagram illustrating an example of mapping information 31a according to the present exemplary embodiment. As illustrated in FIG. 4B, mapping information 31a includes, per service, a service ID uniquely allocated to each service, a channel name, and position information indicating a position of a reduced video image of each service in a reduced video image group (hereinafter such position information will be abbreviated as “reduced video image position information” as appropriate). The reduced video image position information corresponds to position information of application regions L101 to L111 and L201 to L215 of reduced video images illustrated in FIG. 8B described below. Position information may be, for example, a base point (e.g., coordinates at an upper left corner) and lengths (the number of pixels) in a vertical direction and a horizontal direction, or coordinates of two diagonal corners (e.g., coordinates at the upper left corner and coordinates at a lower right corner).

Further, in mapping information 31a, selection information such as a network ID of a channel, a TS (Transport Stream) ID and a service ID, and audio information for extracting from a multiplexed audio an audio corresponding to the channel are stored. The network ID indicates a network type such as digital terrestrial broadcast and BS broadcast, and the TSID and the service ID indicate service types.

In subscription information 31b, whether or not each of a plurality of services is a subscription required service which needs to be subscribed for viewing is stored per receiver ID 25a (per user) and, in the case of the subscription required service, whether each service is subscribed or unsubscribed is further stored.

Template video image 31c is a video image which shows designs of video images of a first selection service and a second selection service. Template video image 31c will be described below in detail.

In permission information 31d, whether each of a plurality of service is a first service whose reduced video image is not permitted to be simultaneously displayed on one screen together with reduced video images of other services, or a second service which is permitted to be simultaneously displayed is stored.

In the present exemplary embodiment, a case where digital terrestrial broadcast is a first service and CS broadcast is a second service will be described as an example for ease of description. However, the present disclosure is not limited to this.

Icon video image group 31e includes a plurality of icon video images. The plurality of icon video images includes icon video images for hiding first reduced video images and second reduced video images. The icon video images include, for example, video images each showing a channel of each service or video images each showing that each subscription required service is unsubscribed. The icon video images are video images including figures or characters, or may be still images. The icon video images are video images different from reduced video images of corresponding services. The icon video images may be characters or figures indicating information of a corresponding service (e.g., a service name, a service logo or a broadcaster logo which provides a service, a character of a broadcaster or a channel number).

Menu application 31f is application data for displaying a recording list, a reservation list, an EPG and homepages. Menu application 31f may include other items of application data such as games.

Communication unit 32 communicates with communication unit 24 of STB 20 through network 40.

[1-4. Configuration of Remote Controller]

Remote controller 50 is a device which operates STB 20. In the present exemplary embodiment, a housing surface of remote controller 50 is configured to include a plurality of keys such as selection keys to which selection services have been allocated, ch keys to which the first service or the second service has been allocated, upper, lower, left and right direction keys, an enter key, a power key, and a recording key. Remote controller 50 includes inside the housing a key input detector circuit which detects a pushed key and an infrared communication unit (not illustrated) which outputs a signal indicating the detected key by way of infrared communication.

[1-5. Configuration of TV]

TV 60 is an example of the video image displaying apparatus, and is, for example, a liquid crystal television or an organic EL television. TV 60 includes a display screen for displaying video images, and an audio output device such as speakers for outputting audios.

TV 60 receives a decoded video signal and audio signal from STB 20, and displays a video image and outputs an audio.

[2. Operation]

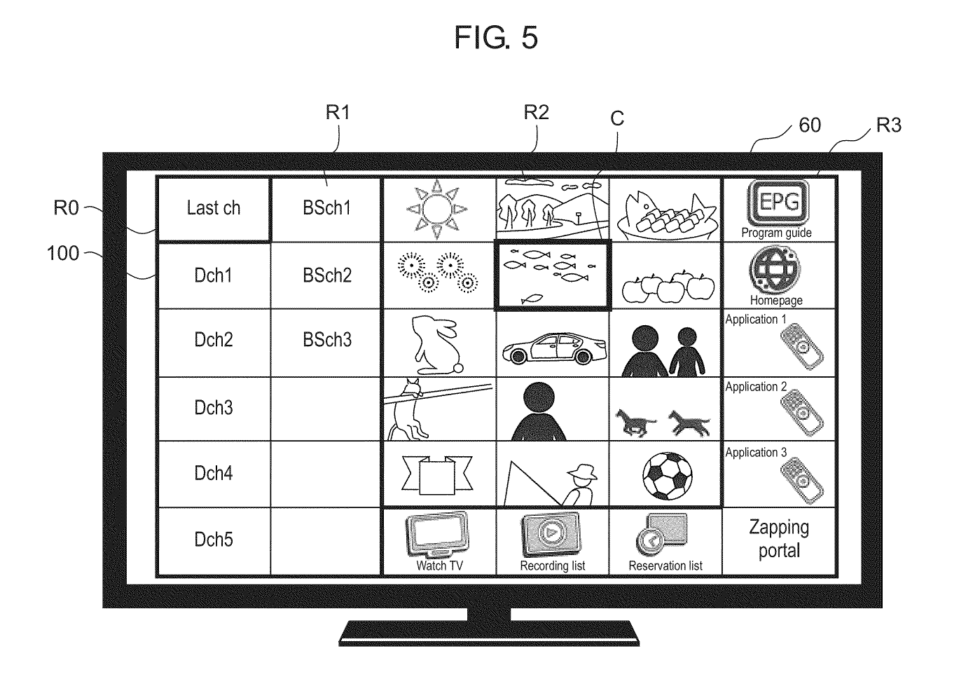

An operation of STB 20 will be described with reference to FIGS. 5 to 10D. STB 20 operates in a plurality of operation modes including a selection mode, a normal mode, a recording mode, and an application mode. In addition, an operation in the recording mode and an operation in another operation mode can be simultaneously executed.

In the selection mode, STB 20 causes TV 60 to display a selection service for selecting one or more services from the first services and the second services.

In the normal mode, STB 20 receives and displays the first service or the second service. In the recording mode, STB 20 records one or a plurality of services selected from a plurality of services including a selection service, the first service and the second service.

In the application mode, STB 20 obtains selected application data from portal server 30, and executes the application data.

[2-1. Selection Mode]

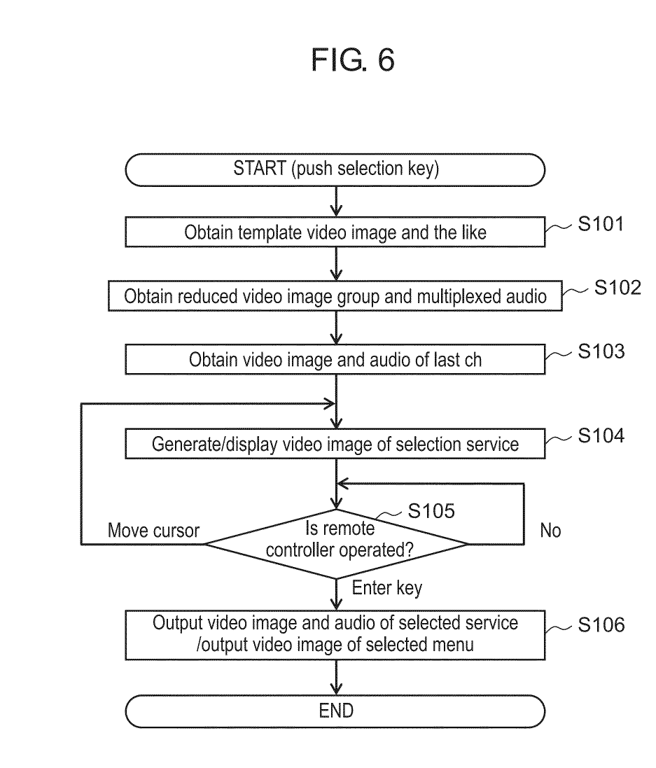

FIG. 5 is a diagram illustrating an example of TV 60 which displays a selection service according to the present exemplary embodiment. FIG. 6 is a flowchart illustrating a process of displaying a selection service according to the present exemplary embodiment.

[2-1-1. Obtaining of Data Required to Generate Video Image of Selection Service]

When the selection key is pushed in a state where a power supply of STB 20 is powered on, STB 20 transitions to the selection mode. In this case, controller 21 stores information of a service, which is broadcast until just before a video image of a selection service is displayed (hereinafter such a service will be referred to as a “last ch” as appropriate), in memory 25. The last ch information is, for example, a channel number.

When transitioning to the selection mode, STB 20 obtains template video image 31c, mapping information 31a, subscription information 31b, permission information 31d, and icon video image group 31e from portal server 30 through communication unit 24 (S101).

FIG. 7 is a diagram illustrating an example of template video image 31c according to the present exemplary embodiment. As illustrated in FIG. 7, template video image 31c includes regions R0 to R3 (a region encircled by bold lines in FIG. 7).

Region R0 includes one display region R001 which displays a reduced video image of the last ch.

Region R1 includes first display regions R101 to R111 of the same shape and size. Each of first display regions R101 to R111 is a region where a reduced video image of digital terrestrial broadcast and BS digital broadcast is displayed in the present exemplary embodiment.

Region R2 includes second display regions R201 to R215 of the same shape and size. Each of second display regions R201 to R215 is a region where a reduced video image of CS broadcast is displayed in the present exemplary embodiment. In addition, in the present exemplary embodiment, the shapes and the sizes of second display regions R201 to R215 are the same as the shapes and the sizes of first display regions R101 to R111.

In addition, for ease of description in the present exemplary embodiment, description will be given of, as an example, a case where digital terrestrial broadcast and BS broadcast are the first services (corresponding to services whose reduced video images are not permitted to be simultaneously displayed on one screen together with reduced video images of other services), and CS broadcast is the second service (corresponding to a service which is permitted to be simultaneously displayed). However, the present disclosure is not limited to this.

Region R3 includes third display regions R301 to R309. In the present exemplary embodiment, third display regions R301 to R305 are regions where icon video images 131 to 135 indicating preset menu applications are displayed. Third display regions R306 to R308 are regions where icon video images 136 to 138 indicating menu applications registered by the user are displayed. Third display region R309 is a region where icon video image 139 indicating a sponsor company of STB 20 is displayed.

In addition, in the present exemplary embodiment, a case where template video image 31c is synthesized with icon video images in advance in region R3 will be described as an example. However, the present disclosure is not limited to this. STB 20 may be configured to obtain template video image 31c which is not synthesized with an icon video image in region R3, icon video images 131 to 139, and STB 20 may be configured to synthesize these icon video images upon generation of a video image of a selection service in step S104 described below.

More specifically, in third display region R301, “Watch TV”, i.e., icon video image 131 for returning to a service used until just before a video image of a selection service is displayed is embedded. In third display region R302, icon video image 132 for displaying a recording list is embedded. In third display region R303, icon video image 133 for displaying a reservation list is embedded. In third display region R304, icon video image 134 for displaying a program guide is embedded. The program guide is, for example, an EPG and is a service different from a selection service. In third display region R305, icon video image 135 for displaying a homepage (a homepage of a company which provides STB 20) is embedded.

Configurations of icon video images R131 to R139 displayed in third display regions R301 to R309, i.e., a number and types of so-called menu applications are not limited to the exemplary embodiment.

Further, the configurations of regions R1 to R3 are not limited to the exemplary embodiment. The size and the shape of each region and the number of display regions can be arbitrarily determined. In addition, in the following description, display regions R001, R101 to R111, R201 to R215 and R301 to R309 illustrated in FIG. 7 will be used to indicate positions of the display regions.

STB 20 obtains a service including data (a reduced video image group and a multiplexed audio) for generating a selection service from a broadcast wave transmitted from broadcast station 10 by using the tuner of broadcast wave receiver 23 (S102).

FIG. 8A is a diagram illustrating an example of reduced video image group SDV according to the present exemplary embodiment. FIG. 8B is a diagram illustrating a relationship between a plurality of reduced video images included in reduced video image group SDV and application regions of reduced video images according to the present exemplary embodiment.

Reduced video image group SDV illustrated in FIG. 8A includes a plurality of first reduced video images and a plurality of second reduced video images. In FIG. 8A, a position of each reduced video image is associated with a position of a selection service for ease of description, but does not necessarily need to be associated with the position of the selection service.

In reduced video image group SDV illustrated in FIG. 8A, first reduced video images 111 to 118 included in first reduced video image group 110 are applied to application regions L101 to L108 illustrated in FIG. 8B. Further, in reduced video image group SDV illustrated in FIG. 8A, a plurality of second reduced video images included in second reduced video image group 120 are applied to application regions L201 to L215 illustrated in FIG. 8B.

Second reduced video image 121 described herein is a reduced video image of an unsubscribed service out of subscription required services which need to be subscribed for viewing. Although described below, the reduced video image is synthesized from above with an icon video image indicating that a service is unsubscribed so as not to display the reduced video image upon generation of a video image of a selection service described below. Second reduced video image 122 described herein is a reduced video image of a subscribed service out of subscription required services. Second reduced video image 123 is a reduced video image of a service which does not need to be subscribed for viewing.

FIG. 8A illustrates that the number of digital terrestrial broadcast services is less than the number of first display regions R101 to R11, and therefore no reduced video images are applied to application regions L109 to L111.

Further, reduced video image group SDV may be individually stored in a state where, instead of one video image illustrated in FIG. 8A, first reduced video image group 110 and second reduced video image group 120 are associated with services. Further, FIG. 8A illustrates that the number of CS broadcast services is not less than the number of second display regions R201 to R215, and reduced video images are displayed in all second display regions R201 to R215. However, there may be some regions in which reduced video images are not displayed.

STB 20 obtains a reduced video image and an audio of a last ch (S103). STB 20 may obtain a reduced video image of a last ch from a reduced video image group, and obtain an audio from a multiplexed audio. When a reduced video image of a last ch is obtained from a reduced video image group, controller 21 specifies a position of the reduced video image of the last ch in the reduced video image group based on mapping information 31a obtained from portal server 30 in step S101 and information of the last ch stored in memory 25. Controller 21 obtains the reduced video image of the last ch by copying the reduced video image of the last ch in the reduced video image group.

In addition, a method of obtaining a reduced video image and an audio of the last ch is not limited to this. For example, in the case where broadcast wave receiver 23 includes two or more tuners, STB 20 may obtain a video image and an audio of a last ch from a broadcast wave by using a tuner different from a tuner which obtains a service including data for generating a selection service from the broadcast wave. STB 20 can obtain a reduced video image and an audio of the last ch by performing processing of reducing the obtained video image of the last ch.

[2-1-2. Generation of Video Image of Selection Service]

STB 20 generates a video image of a selection service, and outputs the generated video image of the selection service and an audio of the selection service obtained from a multiplexed audio to TV 60 (S104).

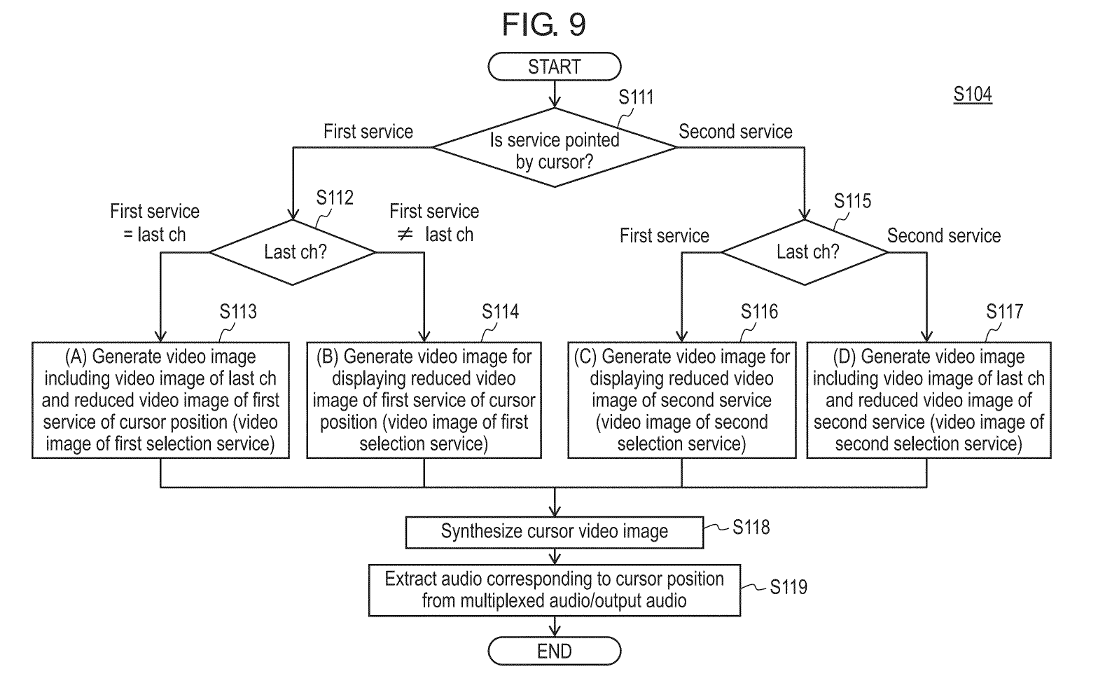

FIG. 9 is a flowchart illustrating an example of a processing process of a method of obtaining a video image and an audio of a selection service according to the present exemplary embodiment.

Controller 21 of STB 20 checks whether a service pointed by cursor C is the first service or the second service (S111). As described above, the first service is a service whose reduced video image is not permitted to be simultaneously displayed on one screen together with reduced video images of other services. The second service is a service which is permitted to be simultaneously displayed.

STB 20 displays a video image of the first selection service when the service pointed by cursor C is the first service. In the video image of the first selection service, a reduced video image of the first service is displayed, and icon video images indicating other services are displayed for the other services.

STB 20 displays a video image of the second selection service when the service pointed by cursor C is the second service. In the video image of the second selection service, reduced video images of the second services are displayed, and icon video images indicating the first services are displayed.

Consequently, it is possible to provide a selection service according to whether or not there is the permission.

Controller 21 specifies the service pointed by cursor C by using cursor position information 25b stored in the memory and specification information 25d illustrated in FIG. 2B. When, for example, the cursor position is at a position of display region R001 of the last ch, controller 21 specifies a service based on the information of the last ch stored in memory 25. When the position of cursor C is at a position other than the last ch, controller 21 specifies the service based on position information 25b (R101 to R111 and R201 to R215) of the cursor stored in memory 25 and specification information 25d illustrated in FIG. 2B. When, for example, cursor position information 25b is at R108, it is possible to specify that the service pointed by cursor C is BSch3 as illustrated in FIG. 2B. When, for example, cursor position information 25b is at R211, it is possible to specify that the service pointed by cursor C is CSch11 based on specification information 25d as illustrated in FIG. 2B.

Controller 21 checks whether the specified service is the first service or the second service by using permission information 31d obtained from portal server 30 in step S101.

When the service pointed by cursor C is the first service (the “first service” in S111), controller 21 checks whether or not the service pointed by cursor C and the last ch are the same (S112). The service pointed by cursor C has already been specified in step S111. The last ch is stored in memory 25 when a selection service starts being displayed. Controller 21 checks whether or not the first service pointed by cursor C and the last ch are the same by comparing these pieces of information.

When the first service pointed by cursor C and the last ch are the same (“first service=last ch” in S112), controller 21 generates a video image of the first selection service for displaying the last ch and a reduced video image of the first service pointed by cursor C (S113). In the video image of the first selection service, reduced video images of other services are not displayed.

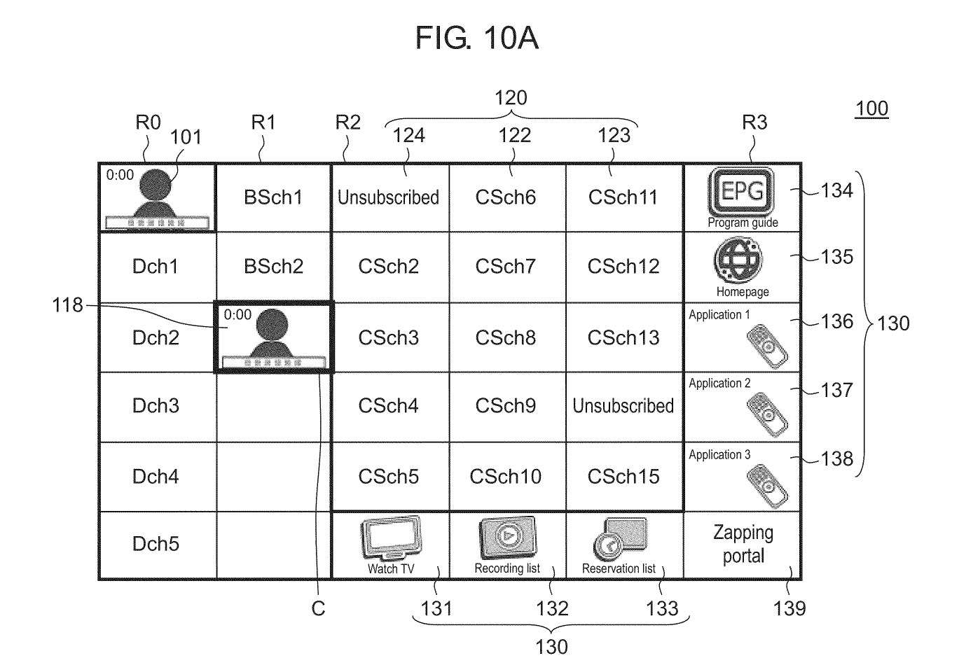

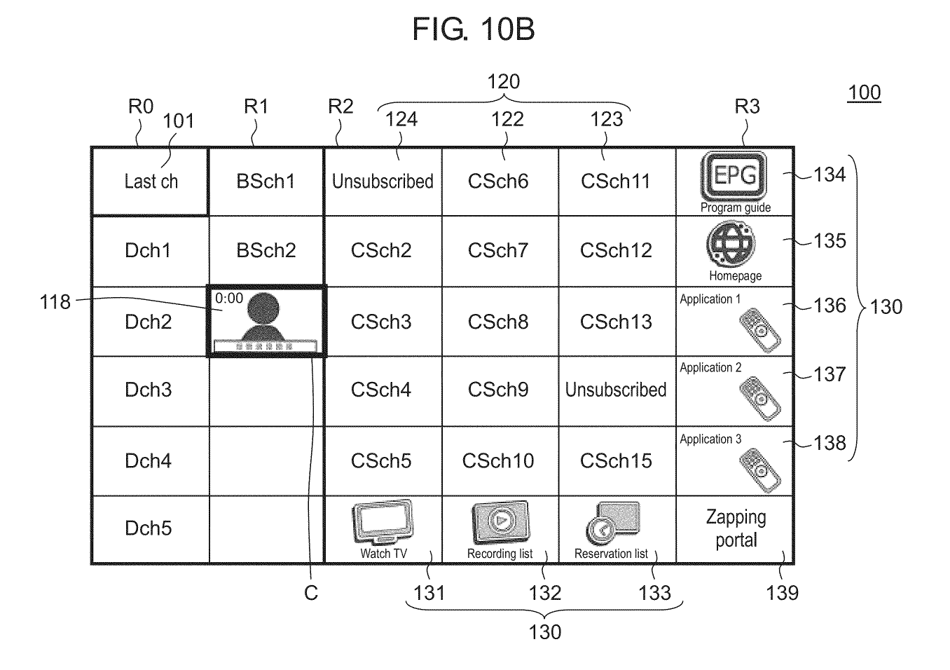

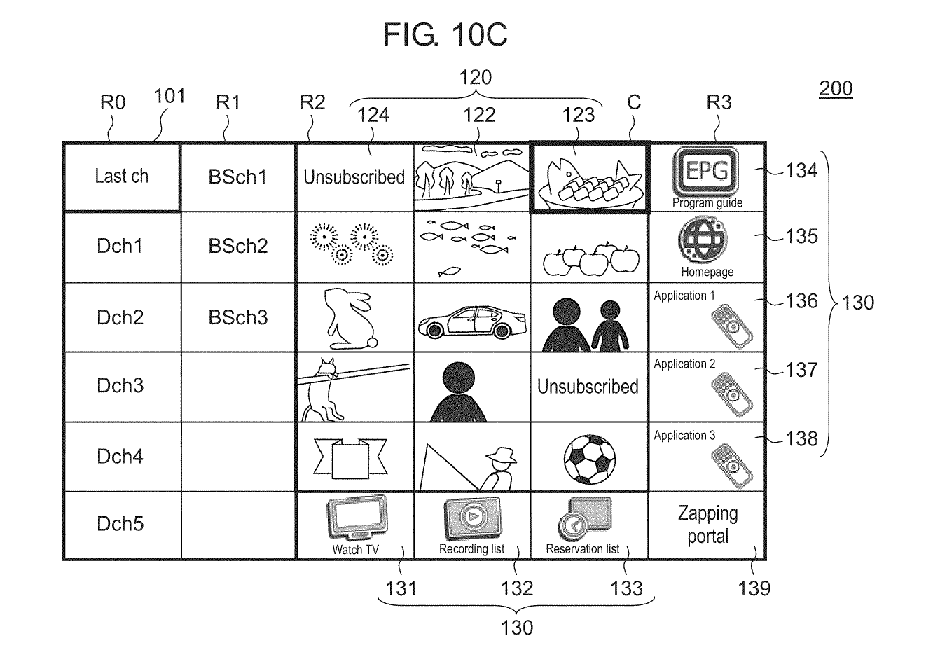

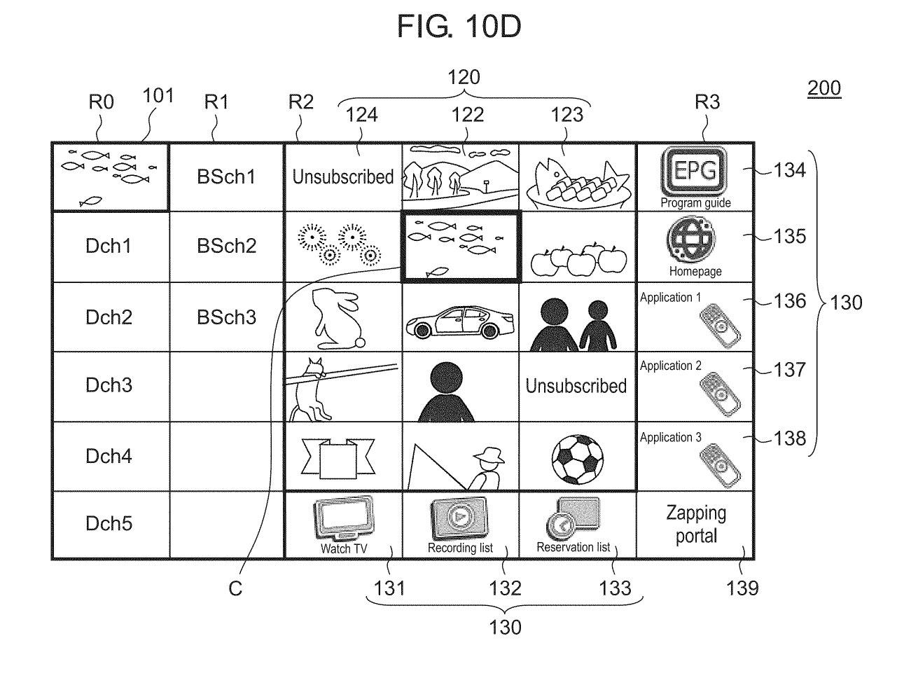

FIG. 10A is a diagram illustrating an example of a video image of first selection service 100 according to the present exemplary embodiment. In the video image of the first selection service, a first reduced video image of the first service pointed by cursor C is displayed, and reduced video images of the other services are not displayed. FIG. 10A illustrates the reduced video image of the first service pointed by cursor C and, in addition, a reduced video image of the last ch, too.

In FIG. 10A, the first service pointed by cursor C is BSch3. Further, the service which a user has last viewed is BSch3. In FIG. 10A, the first service pointed by cursor C and the last ch are the same, and therefore reduced video image 101 of the last ch and reduced video image 118 of BSch3 are displayed. Further, in display regions other than BSch3 of regions R1 and R2, icon video images indicating corresponding services are displayed.

Controller 21 synthesizes template video image 31c and a reduced video image group, and generates a synthesized video image. When an arrangement of each reduced video image in a reduced video image group obtained from a broadcast wave and an arrangement of a reduced video image group of specification information 25d do not match, controller 21 rearranges the reduced video images included in the reduced video image group illustrated in FIG. 8A to positions indicated by specification information 25d by using mapping information 31a and specification information 25d. Controller 21 synthesizes the rearranged reduced video image group and the template video image, and generates a synthesized video image. In addition, in the case where the synthesized video image has already been created in past processing, the synthesized video image which has already been created may be used.

Controller 21 performs so-called mask processing on the synthesized video image to synthesize icon video images with display regions in which reduced video images are not displayed. For each of a plurality of display regions included in regions R1 and R2 except for first display region R108, controller 21 obtains a corresponding icon video image from icon video image group 31e obtained from portal server 30 in step S101. Controller 21 synthesizes a corresponding icon video image with each of a plurality of display regions included in regions R1 and R2 except for first display region R108.

Further, controller 21 synthesizes an icon video image indicating unsubscription, with a corresponding display region for a service stored as an unsubscribed service in subscription information 31b obtained from portal server 30 in step S101. In FIG. 10A, in second display region R201 corresponding to an unsubscribed subscription required service, icon video image 124 indicating unsubscription is synthesized. Thus, second reduced video image 121 illustrated in FIG. 8A is hidden by icon video image 124. Similarly, in second display region R201 corresponding to an unsubscribed subscription required service, too, an icon video image indicating unsubscription is synthesized on the second reduced video image. In second display region R206 corresponding to a subscribed subscription required service, an icon video image is not synthesized, and second reduced video image 122 indicating the service is eventually displayed.

To sum up, in display region R001 in a video image of first selection service 100 illustrated in FIG. 10A, a video image of the last ch is displayed. In first display regions R101 to R107, icon video images corresponding to Dch1 to Dch5, and BSch1 and BSch2 are displayed. In first display region R108, a video image of BSch3 is displayed. In first display regions R109 to R111, video images indicating that there is no corresponding service or blank fields (white video images) are displayed. In second display regions R202 to R213 and R215, icon video images corresponding to CSch2 to CSch13 and CSch15 are displayed. In second display regions R201 and R214, icon video images indicating unsubscription are displayed.

When the first service pointed by cursor C and the last ch are not the same (“first service≠last ch” in S112), controller 21 generates a video image of the first selection service for displaying a reduced video image of the first service pointed by cursor C (S114). In the video image of the first selection service, reduced video images of other services including the last ch are not displayed.

FIG. 10B is a diagram illustrating another example of a video image of first selection service 100 according to the present exemplary embodiment. In the video image of the first selection service, a first reduced video image of the first service pointed by cursor C is displayed, and reduced video images of the other services are not displayed. In FIG. 10B, a reduced video image of the last ch is not displayed unlike FIG. 10A.

In FIG. 10B, the first service pointed by cursor C is BSch3. Further, a service which the user has last viewed is a service such as BSch1 other than BSch3. In FIG. 10B, the first service pointed by cursor C and the last ch are different, and therefore reduced video image 118 of BSch3 is displayed and the reduced video image of the last ch is not displayed. Further, in display regions other than BSch3 of regions R1 and R2, icon video images indicating corresponding services are displayed.

Similar to the case in FIG. 10A, controller 21 synthesizes template video image 31c and a reduced video image group, and generates a synthesized video image. When an arrangement of each reduced video image in a reduced video image group obtained from a broadcast wave and an arrangement of a reduced video image group of specification information 25d do not match, controller 21 rearranges a plurality of reduced video images included in the reduced video image group, then synthesizes template video image 31c and the rearranged reduced video image group and generates a synthesized video image.

Controller 21 synthesizes a corresponding icon video image with the synthesized video image in each of a plurality of display regions included in regions R1 and R2 except for first display region R108. Controller 21 synthesizes an icon video image indicating a display region of the reduced video image of the last ch, with display region R001 included in region R0. Further, controller 21 synthesizes an icon video image indicating unsubscription, with a corresponding display region for a service stored as an unsubscribed service in subscription information 31b obtained from portal server 30 in step S101.

To sum up, in display region R001 in a video image of first selection service 100 illustrated in FIG. 10B, an icon video image indicating the display region of the last ch is displayed. In first display regions R101 to R107, icon video images corresponding to Dch1 to Dch5, and BSch1 and BSch2 are displayed. In first display region R108, a video image of BSch3 is displayed. In first display regions R109 to R111, video images indicating that there is no corresponding service or blank fields (white video images) are displayed. In second display regions R202 to R213 and R215, icon video images corresponding to CSch2 to CSch13 and CSch15 are displayed. In second display regions R201 and R214, icon video images indicating unsubscription are displayed.

When the service pointed by cursor C is the second service (“second service” in S111), controller 21 checks whether the last ch is the first service or the second service (S115). Controller 21 specifies the service based on information of the last ch stored in memory 25, and checks whether the last ch is the first service or the second service by using permission information 31d obtained from portal server 30 in step S101.

When the last ch is the first service (“first service” in S115), controller 21 generates a video image of the second selection service in which reduced video images of a plurality of second services are displayed (S116). In the video image of the second selection service, the reduced video image of the last ch and reduced video images of the first services are not displayed.

FIG. 10C is a diagram illustrating an example of a video image of second selection service 200 according to the present exemplary embodiment. In the video image of the second selection service, a plurality of second reduced video images is displayed, and a plurality of first reduced video images is not displayed. In FIG. 10C, the reduced video image of the last ch is not displayed.

In FIG. 10C, the second service pointed by cursor C is CSch11. Further, the service which a user has last viewed is the first service. In FIG. 10C, the last ch is the first service, and therefore the reduced video image of the last ch is not displayed. In FIG. 10C, second reduced video image group 120 including second reduced video image 122 and second reduced video image 123 is displayed.

Similar to the case in FIG. 10A, controller 21 synthesizes template video image 31c and a reduced video image group, and generates a synthesized video image. When an arrangement of each reduced video image in a reduced video image group obtained from a broadcast wave and an arrangement of a reduced video image group of specification information 25d do not match, controller 21 rearranges a plurality of reduced video images included in the reduced video image group, then synthesizes template video image 31c and the rearranged reduced video image group and generates a synthesized video image.

Controller 21 synthesizes icon video images indicating Dch1 to Dch5 and BSch1 to BSch3 with the synthesized video image in each of first display regions R101 to R108 included in region R1. Controller 21 synthesizes an icon video image indicating the display region of the reduced video image of the last ch, with display region R001. Further, controller 21 synthesizes an icon video image indicating unsubscription, with a corresponding display region for a service stored as an unsubscribed service in subscription information 31b obtained from portal server 30 in step S101.

To sum up, in display region R001 in a video image of second selection service 200 illustrated in FIG. 10C, an icon video image indicating the display region of the last ch is displayed. In first display regions R101 to R108, icon video images corresponding to Dch1 to Dch5, and BSch1 to BSch3 are displayed. In first display regions R109 to R111, video images indicating that there is no corresponding service or blank fields (white video images) are displayed. In second display regions R202 to R213 and R215, video images corresponding to CSch2 to CSch13 and CSch15 are displayed. In second display regions R201 and R214, icon video images indicating unsubscription are displayed.

When the last ch is the second service (“second service” in S115), controller 21 generates a video image of the second selection service in which the last ch and reduced video images of a plurality of second services are displayed (S117). In the video image of the second selection service, reduced video images of the first services are not displayed.

FIG. 10D is a diagram illustrating another example of a video image of second selection service 200 according to the present exemplary embodiment. In the video image of the second selection service, a plurality of second reduced video images is displayed, and a plurality of first reduced video images is not displayed. In FIG. 10D, the reduced video image of the last ch is displayed unlike FIG. 10C.

In FIG. 10D, the second service pointed by cursor C is CSch7. Further, the service which the user has last viewed is the second service. In FIG. 10D, the service pointed by cursor C and the last ch are the second services, and therefore second reduced video image group 120 including second reduced video image 122 and second reduced video image 123, and reduced video image 101 of the last ch are displayed.

Similar to the case in FIG. 10A, controller 21 synthesizes template video image 31c and a reduced video image group, and generates a synthesized video image. When an arrangement of each reduced video image in a reduced video image group obtained from a broadcast wave and an arrangement of a reduced video image group of specification information 25d do not match, controller 21 rearranges a plurality of reduced video images included in the reduced video image group, then synthesizes template video image 31c and the rearranged reduced video image group and generates a synthesized video image.

Controller 21 synthesizes icon video images indicating Dch1 to Dch5 and BSch1 to BSch3 with the synthesized video image in each of first display regions R101 to R108 included in region R1. Further, controller 21 synthesizes an icon video image indicating unsubscription, with a corresponding display region for a service stored as an unsubscribed service in subscription information 31b obtained from portal server 30 in step S101.

To sum up, in display region R001 in a video image of second selection service 200 illustrated in FIG. 10D, the video image of the last ch is displayed. In first display regions R101 to R108, icon video images corresponding to Dch1 to Dch5, and BSch1 to BSch3 are displayed. In first display regions R109 to R111, video images indicating that there is no corresponding service or blank fields (white video images) are displayed. In second display regions R202 to R213 and R215, video images corresponding to CSch2 to CSch13 and CSch15 are displayed. In second display regions R201 and R214, icon video images indicating unsubscription are displayed.

Controller 21 executes one of steps S113 to S117, and then synthesizes the video image of cursor C with the generated video image (S118). In the present exemplary embodiment, controller 21 synthesizes cursor video image 25c stored in memory 25 with the video image generated in one of steps S113 to S117. Cursor video image 25c is synthesized at the position indicated by cursor position information 25b.

Thus, the video image of the selection service is generated. In addition, cursor video image 25c may be configured to be obtained from portal server 30. Further, when information for generating cursor video image 25c is stored in memory 25 instead of cursor video image 25c, controller 21 generates cursor video image 25c, and synthesizes generated cursor video image 25c with the video image generated in one of steps S113 to S117.

Controller 21 outputs the generated video image of the selection service to TV 60.

Controller 21 obtains an audio of the service pointed by cursor C from a multiplexed audio, and outputs the audio to TV 60. In addition, the service pointed by cursor C has already been specified upon execution of step S104.

[2-1-3. Remote Controller Operation]

As illustrated in FIG. 6, when step S104 is executed, a video image of a selection service is displayed on TV 60 and, when the direction key of remote controller 50 is pushed in a state where the speakers of TV 60 output an audio of the service pointed by cursor C (“moving of the cursor” in S105), processing moves to step S104. STB 20 moves the cursor according to the pushed direction key, and specifies a service pointed by the cursor which has been moved.

When the service pointed by the cursor is switched between the first service and the second service, STB 20 switches the video image to output to TV 60 between the video image of the first selection service and the video image of the second selection service according to cursor C which has been moved. When the service pointed by the cursor is switched between the first services, STB 20 switches a reduced video image which is eventually displayed, in the video image of the first selection service. STB 20 switches the audio to output to TV 60, from the audio of the service pointed by the cursor which is not yet moved, to the audio of the service pointed by the cursor which has been moved.

When the enter key of remote controller 50 is pushed (“the enter key” in S105) in a state where the video image of the selection service is displayed (S104), the selection mode is finished.

When the position of cursor C upon pushing of the enter key is in a display region included in one of regions R0 to R2 (except for first display regions R109 to R111 which are not associated with a service) or in third display region R301, STB 20 transitions to the normal mode, and outputs a video image and an audio of the service pointed by cursor C, to TV 60.

When the position of cursor C upon pushing of the enter key is in third display regions R302 to R308 included in region R3, STB 20 transitions to the application mode, and obtains menu application 31f associated with the display region from portal server 30. STB 20 activates obtained menu application 31f, and displays a screen of menu application 31f (e.g., the recording list or the reservation list).

[2-2. Normal Mode]

In the normal mode, STB 20 obtains a video image and an audio of a service to view, from broadcast waves by using the tuner of broadcast wave receiver 23. STB 20 outputs the obtained video image and audio from video image/audio output unit 26 to TV 60.

Consequently, it is possible to cause the screen of TV 60 to display a video image of the first service or the second service, and cause the speakers (not illustrated) of TV 60 to output an audio of the service.

[2-3. Recording Mode]

STB 20 transitions to the recording mode when recording start times of one or a plurality of services whose recording has been reserved by using the EPG or the like come and when the recording key of remote controller 50 is pushed. In addition, when broadcast wave receiver 23 includes two or more tuners, it is possible to execute an operation related to the recording mode in parallel to execution of an operation related to the normal mode or the selection mode.

Recording of a selection service will now be described. STB 20 according to the present exemplary embodiment can record a selection service. The selection service is included as one of a plurality of services in broadcast waves, and can be recorded similar to the normal first services and second services. Recording is performed by using the hard disk of memory 25. However, when STB 20 has a function of recording services in another medium such as an externally connected hard disk, a DVD (Digital Versatile Disc) or a BD (Blu-ray (registered trademark) Disc), this function may be used.

When recording of a selection service is reserved or when the recording key of remote controller 50 is pushed while a video image and an audio of the selection service are output to TV 60, STB 20 records the selection service.

Upon recording of a selection service, STB 20 stores recording data including template video image 31c, a reduced video image group, a multiplexed audio, mapping information 31a, subscription information 31b, permission information 31d, icon video image group 31e and specification information 25d. Upon playback of the selection service, STB 20 generates a video image of the selection service by using these items of recording data, and obtains audios from the multiplexed audio included in the items of recording data. STB 20 outputs the generated video image and audio of the selection service to TV 60.

Further, upon playback of the recorded selection service, when one of the first services and the second services is selected, controller 21 enlarges the reduced video image of the selected service and displays the video image on the full screen. In addition, the audio of the service included in a multiplexed audio is extracted and output as the audio when cursor C moves, and therefore the audio of the service is continuously output.

In addition, depending on intentions of advertisers or right holders (broadcasters which provide services), subscription information 31b or permission information 31d may be configured to be newly obtained upon playback.

When subscription information 31b upon playback is used to play back the selection service, even in the case of a service which is not subscribed upon recording, a reduced video image of the service or an enlarged video image of the reduced video image can be viewed if a service is subscribed upon playback.

Similarly, when permission information 31d upon playback is used to play back the selection service, even in the case of a service whose reduced video image is not permitted to be simultaneously displayed on one screen together with reduced video images of other services upon recording, a reduced video image of the service may be simultaneously displayed on one screen together with the reduced video images of other services if the permissions are obtained upon playback. That is, when a permission of a service which is the first service upon recording is obtained upon playback, the service may be classified as the second service.

Further, if the service is subscribed in one of subscription information 31b upon recording and subscription information 31b upon playback, the reduced video image of the service may be configured to be available.

Further, when permission information 31d upon playback is used to play back a selection service, even in the case of a service classified as the first service whose reduced video image is not permitted to be simultaneously displayed together with reduced video images of other services upon recording, a reduced video image of the service, which becomes the second service whose permission is obtained upon playback, may be simultaneously displayed together with reduced video images of other second services.

By contrast with this, even in the case of a service classified as the second service upon recording, a reduced video image of the service, which becomes the first service upon playback, may not be simultaneously displayed together with reduced video images of other services.

[3. Effect and Others]

For the first service whose reduced video image is not permitted to be simultaneously displayed on one screen together with reduced video images of other services, STB 20 according to the present exemplary embodiment provides the first selection service for not displaying the reduced video images of other services while the reduced video image of the first service is displayed. Further, for the second service whose permission is obtained, the second selection service for simultaneously displaying second reduced video images of one or a plurality of second services on one screen is provided. Consequently, it is possible to provide an appropriate selection service according to whether or not there is the permission.

According to the second selection service, video images (moving images) of a plurality of the second services are simultaneously displayed. Consequently, the user viewing TV 60 can visually recognize a plurality programs. Consequently, it is possible to allow the user to smoothly select a service, improve convenience, and reduce power consumption with reduction in a number of operations.

In addition, generally speaking, when STB 20 tries to generate a reduced video image, one tuner is necessary for one reduced video image. In the present exemplary embodiment, broadcast station 10 generates a reduced video image. Consequently, STB 20 can simultaneously display reduced video images of a plurality of services without having tuners whose number corresponds to a total number of a plurality of services.

Further, in the present exemplary embodiment, broadcast station 10 generates a reduced video image group. Consequently, STB 20 only needs to perform processing with a comparatively low load such as icon video image and cursor drawing processing, does not need video image reduction processing, and therefore does not need special video processing capability.

### Modified Example 1

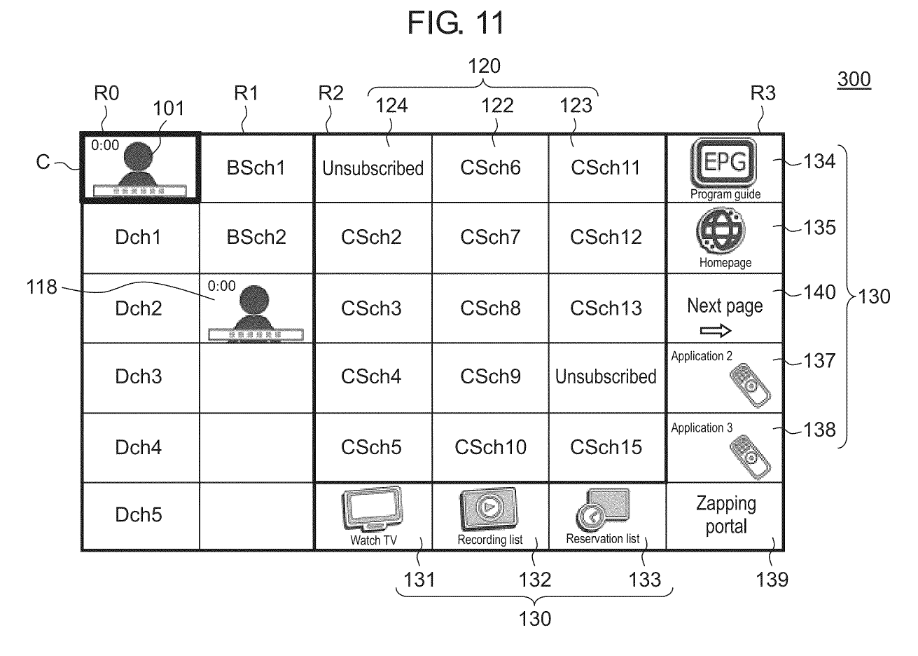

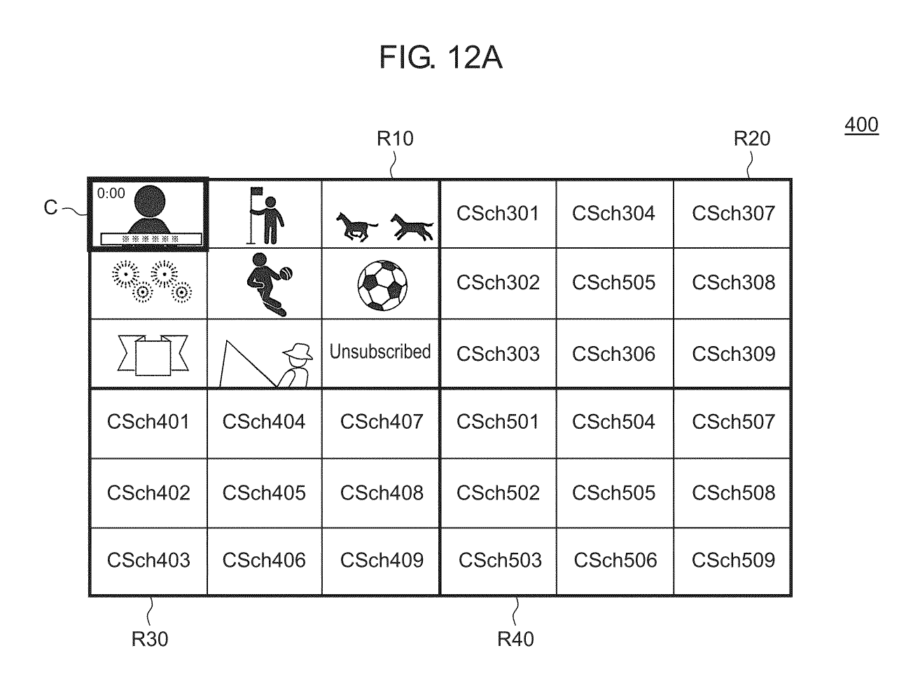

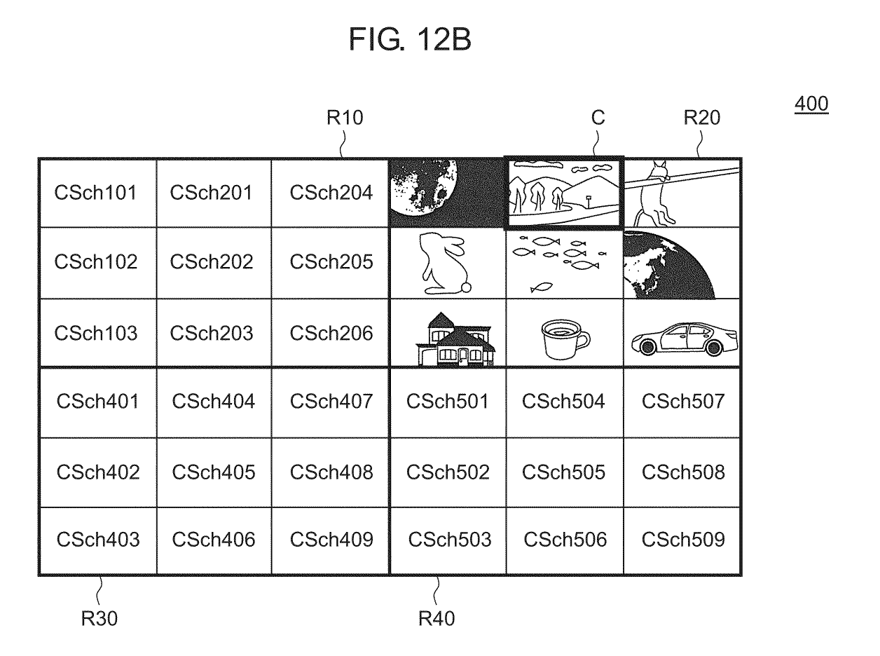

A video image receiving apparatus and a video image receiving method according to a modified example 1 will be described with reference to FIGS. 11, 12A and 12B.

In the present modified example, a case where reduced video images of a plurality services are displayed over a plurality of pages in, for example, a selection mode will be described. In addition, the present modified example is particularly useful, when the number of reduced video images of second services is large, and a video image of a first selection service is not enough.

FIG. 11 is a diagram illustrating an example of a video image of a selection service on a first page according to the present modified example. FIGS. 12A and 12B are diagrams illustrating examples of video images of a selection service on second and subsequent pages according to the present modified example.

A difference of a video image of a selection service in FIG. 11 from the video image of the selection service in FIGS. 10A to 10D is that icon video image 140 for displaying a next page is disposed at a portion at which icon video image 136 of application 1 is provided in FIGS. 10A to 10D. When cursor C is moved from a position illustrated in FIG. 11 and an enter key of remote controller 50 is pushed in a state where cursor C is adjusted to the position of icon video image 140, a page moves to second or subsequent pages illustrated in FIGS. 12A and 12B.

In addition, a case where icon video image 140 for displaying the next page is displayed at a portion at which icon video image 136 of application 1 has been provided has been described. However, the present disclosure is not limited to this. When the video image of the selection service in FIGS. 10A to 10D is displayed, the cursor is positioned in a display region at a right end, and the direction key for moving the remote controller to the right is pushed, other pages may be displayed. Similarly, when the cursor is positioned in a display region at a left end, an upper end or a lower end, and the direction key indicating the left, the up or the down of the remote controller is further pushed, other pages may be displayed. Further, when cursor C is positioned in a display region at an upper, lower, left or right end, an icon (e.g., an arrow) indicating that there is a next page may be displayed.

In FIGS. 12A and 12B, four regions R10, R20, R30 and R40 of 2×2 are arranged, and display regions of 3×3 are displayed in each region. That is, in FIGS. 12A and 12B, display regions of 6×6 are arranged.

In each region, one or a plurality of genres is allocated. For example, the genres of region R10 include news and sports. In region R10, reduced video images of services of broadcasters which broadcast news programs or sports programs are mainly displayed. Further, for example, a genre of region R20 is a movie. In region R20, reduced video images of services of broadcasters which broadcast mainly movies are displayed. Similarly, themes are defined for regions R30 and R40, too.

In addition, in the present modified example, one or a plurality of genres has been allocated to each region. However, reduced video images to be arranged in regions are not limited to the above example, and for example, reduced video images may be arranged in regions per user or in order of services which a user frequently views. Further, in the present modified example, sizes of regions R10, R20, R30 and R40 are the same. However, the present disclosure is not limited to this.

Controller 21 displays reduced video images in display regions belonging to a region in which cursor C is positioned in a video image of a selection service on second and subsequent pages configured as described above. Controller 21 displays icon video images of corresponding services in display regions belonging to a region in which cursor C is not positioned. In addition, the video images illustrated in FIGS. 12A and 12B may be used as video images on the first page.

In the present modified example, too, it is possible to provide the same effect as that in the first exemplary embodiment.

### Modified Example 2

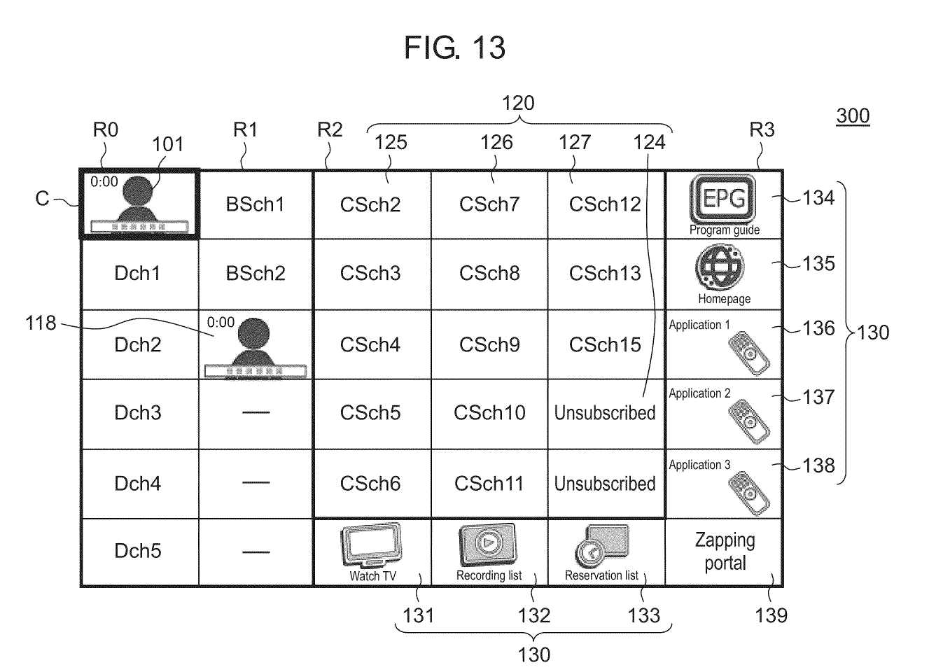

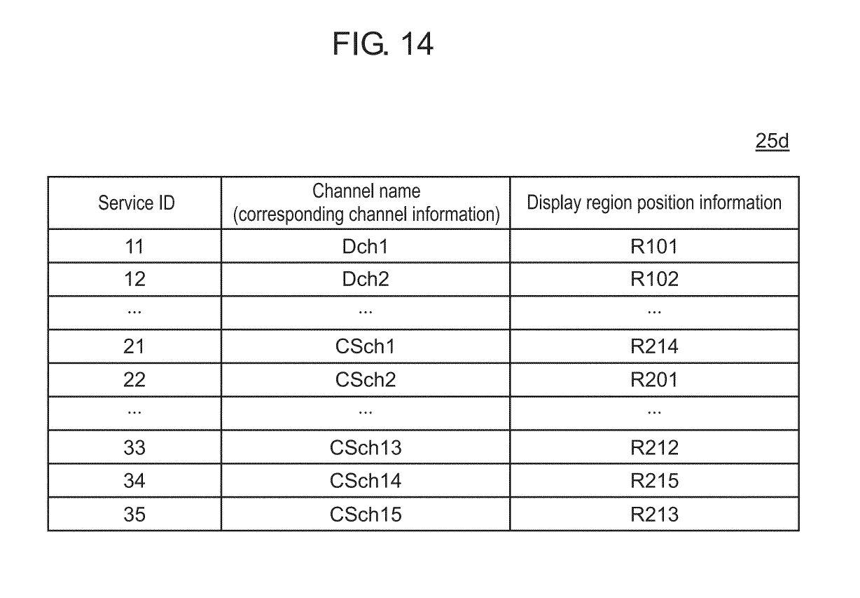

A video image receiving apparatus and a video image receiving method according to a modified example 2 will be described with reference to FIGS. 13 and 14.

In the present modified example, description will be given of a case where positions of display regions in which reduced video images of first services and second services are displayed are configured to allow the user to customize.

In the present modified example, an operation mode includes a registration mode.

In the registration mode, STB 20 changes a specification of a screen of a current selection mode according to a user's operation.

Memory 25 of STB 20 stores a specification of a screen of the current selection mode, i.e., specification information in which positions of display regions for displaying reduced video images per each of a plurality of services are stored. Information illustrated in FIG. 2B is stored as a default value of specification information 25d.

FIG. 13 is a diagram illustrating an example of a video image of first selection service 300 obtained after a specification change according to the present modified example. FIG. 14 is a diagram illustrating an example of specification information 25d obtained after the specification change according to the present modified example.

In the examples illustrated in FIGS. 13 and 14, a reduced video image is replaced in region R2. More specifically, unsubscribed services are collected at a lower right of region R2. In FIGS. 13 and 14, CSch2 to CSch13 and CSch15 are associated with second display regions R201 to R213, and CSch1 and CSch14 are associated with second display regions R214 and R215.

Thus, it is also possible to collect, for example, services which a user has little chance to view. In other words, according to a number of chances that the user views services, it is possible to rearrange display positions of reduced video images. Consequently, the user can more easily select services. Further, it is possible to provide the same effect as the effect in the first exemplary embodiment.

### Other Exemplary Embodiments

The exemplary embodiment has been described above as an exemplary technique disclosed in the present application. However, the technique according to the present disclosure is not limited this, and is also applicable to exemplary embodiments in which modifications, replacements, additions, and omission are performed as appropriate. Hereinafter, other exemplary embodiments will be described.

(1) In the above exemplary embodiment, the modified example 1 and the modified example 2, an example of video images illustrated in FIGS. 10A to 10D has been described as a video image of a selection service. However, the present disclosure is not limited to this. In a video image of a selection service, another information may further be displayed in the video images illustrated in FIGS. 10A to 10C.

For example, in each of first display regions R101 to R111 and second display regions R201 to R215, a channel number may also be displayed.

(2) In the above exemplary embodiment, the modified example 1 and the modified example 2, an icon video image indicating that an unsubscribed subscription required service is unsubscribed has been displayed. However, the present disclosure is not limited to this.

Depending on intentions of broadcasters which provide subscription required services, instead of completely replacing video images of the subscription required services, for example, reduced video images of the subscription required services may be displayed as is together with information indicating “unsubscription”. For example, the information indicating “unsubscription” is displayed on a video image of a subscription required service or in surroundings (a frame portion) of the video image.

Further, when information indicating that the subscription required service can be temporarily viewed is stored in subscription information 31b, even in the case of the “unsubscribed” subscription required service, or when a period in which the subscription required service can be temporarily viewed is specified by broadcast station 10, controller 21 may display a reduced video image for the subscription required service. In this case, controller 21 may further add information indicating that the subscription required service can be temporarily viewed, to a video image of the subscription required service or a surrounding (e.g., a frame portion) of the video image. According to this configuration, it is possible to encourage the user to subscribe a subscription required service (advertise the subscription required service).

(3) In the present exemplary embodiment, the modified example 1 and the modified example 2, controller 21 stores data for displaying a selection service when recording the selection service in the recording mode. The present disclosure is not limited to this. First selection service video images and second selection service video images generated in step S104 (FIG. 9) in FIG. 6 may be stored.

(4) In the exemplary embodiment, the modified example 1 and the modified example 2, broadcast station 10 is configured to generate a multiplexed audio and include an audio in a broadcast wave output to STB 20. The present disclosure is not limited to this.

When, for example, broadcast wave receiver 23 of STB 20 includes two or more tuners, broadcast wave receiver 23 may be configured to decode a video image of a selection service by using one tuner, and to decode a normal audio of a service selected by cursor C of the selection service instead of a multiplexed audio by another tuner.

In this case, broadcast station 10 does not need to generate and output a multiplexed audio. In this regard, broadcast station 10 may be configured to generate a multiplexed audio in order to record a selection service.

(5) In the exemplary embodiment, the modified example 1 and the modified example 2, subscription information 31b is obtained from portal server 30. However, the present disclosure is not limited to this. For example, a plurality of services included in a broadcast wave may be tuned in order so as to determine whether or not each service is subscribed. Further, a reference to information included in a terminal or a CAS (Conditional Access Systems) card may be made.

(6) In the exemplary embodiment, the modified example 1 and the modified example 2, communication unit 24 of STB 20 is configured to obtain mapping information 31a or the like from portal server 30 when a mode transitions to a selection mode. However, the present disclosure is not limited to this. A timing to obtain mapping information 31a or the like may be another timing such as a timing when STB 20 is powered on. Alternatively, mapping information 31a or the like may be downloaded in advance to STB 20, and be notified from broadcast station 10 or portal server 30 upon update, or be received from broadcast wave receiver 23 or communication unit 24.

(7) In the exemplary embodiment, the modified example 1 and the modified example 2, mapping information 31a or the like is obtained from portal server 30. However, the present disclosure is not limited to this. Broadcast station 10 may generate a broadcast wave including these pieces of information, and STB 20 may extract these pieces of information from the broadcast wave.

(8) In the exemplary embodiment, the modified example 1 and the modified example 2, a case where STB 20 receives a broadcast wave of cable broadcast from broadcast station 10 has been described as an example. However, the present disclosure is not limited to this. For example, STB 20 may receive IP content on the Internet as part or all of services. Alternatively, in the exemplary embodiment, the modified example 1 and the modified example 2, a case where a video image receiving apparatus is STB20 has been described as an example. The present disclosure is not limited to this, and the video image receiving apparatus may be, for example, another apparatus which receives IP content on the Internet.

(9) In the exemplary embodiment, the modified example 1 and the modified example 2, the controller is a CPU or an arithmetic operation processor. However, the controller may be physically configured in any way as long as the controller controls the video image receiving apparatus. In addition, as long as controller 21 is configured as a CPU (or a microcomputer) and is configured to control the video image receiving apparatus by executing a control program, it is possible to change processing contents by changing the control program. Consequently, it is possible to increase the degree of freedom in design of controller 21. Further, controller 21 may be realized by a hard logic. Realizing controller 21 as a hard logic is effective to increase a processing speed. Controller 21 may be configured as one element or may be physically configured as a plurality of elements. When controller 21 is configured as a plurality of elements, each control recited in the claims may be realized by another element. In this case, it may be understood that a plurality of these elements configures one controller 21. Further, a member which has a function different from the function of controller 21 may be configured as one element.

(10) In the exemplary embodiment, the modified example 1 and the modified example 2, a case where infrared communication is used for communication between STB 20 and remote controller 50 has been described. However, the present disclosure is not limited to this.

(11) In the exemplary embodiment, the modified example 1 and the modified example 2, broadcast station 10 generates a reduced video image group. However, STB 20 or portal server 30 may generate a reduced video image group.

In addition, a video image of a first selection service can be generated by fitting one first reduced video image to a template video image. Consequently, it is possible to generate the video image of the first selection service from a broadcast wave by using one tuner. Hence, video images may be dispersed and generated in such a way that STB 20 generates a video image of a first selection service, and broadcast station 10 generates a video image of a second selection service.

(12) In the above exemplary embodiment, the modified example 1 and the modified example 2, in display regions where there is no corresponding service, blank fields or icon video images indicating that there is no corresponding service have been displayed. However, the present disclosure is not limited to this. In such so-called margin regions, other pieces of arbitrary information may be displayed. Examples of other pieces of arbitrary information may include information of a service selected by cursor C, information of a product related to a service selected by cursor C, information of other recommendation services, and TV shopping images.

(13) In the exemplary embodiment, the modified example 1 and the modified example 2, STB 20 obtains a video image and an audio of a service from a broadcast wave. However, the present disclosure is not limited to this. A video image and an audio of a service (e.g., a video image and an audio of IP (Internet Protocol) broadcast) may be received from a network through communication unit 24. Alternatively, when STB 20 includes a communication unit which supports other communication paths (power line communication and wireless communication), a video image and an audio of a service may be obtained by using a communication unit which supports other communication paths.

(14) In the exemplary embodiment, the modified example 1 and the modified example 2, a case where cursor position information 25b is initialized to a position of an upper left display region when a video image of a selection service starts being displayed has been described as an example. The present disclosure is not limited to this. For example, a position upon an end of display of a video image of a selection service may be held as is, and the user or the broadcast station may be configured to be allowed to specify a specific position.

(15) In the exemplary embodiment, the modified example 1 and the modified example 2, a case where specification information 25d includes a service ID, a channel name of each service, and display region position information has been described. However, the present disclosure is not limited to this. Part of services may not include display region position information. Further, specification information 25d may further include other pieces of information such as a genre of each service.

(16) In the exemplary embodiment, the modified example 1 and the modified example 2, a case where each of a plurality of tuners of tuner 12 of broadcast station 10 decodes a first broadcast wave to a video image and an audio of a corresponding service has been described. However, the present disclosure is not limited to this. For example, a video and an audio of each service may be obtained for part or all services by using a dedicated line.

(17) In the exemplary embodiment, the modified example 1 and the modified example 2, audio multiplexer 14 multiplexes audios of a plurality of services output from a plurality of tuners which composes tuner 12, and generates a multiplexed audio. However, the present disclosure is not limited to this. The multiplexed audio may include other audios such as ambient music.

In this case, when a video image of a selection service is displayed, ambient music may be output instead of an audio of a service pointed by cursor C.

(18) In the exemplary embodiment, the modified example 1 and the modified example 2, a case where, when a selection key is pushed, a mode transitions to the selection mode has been described. However, the present disclosure is not limited to this. STB 20 may transition to the selection mode when the power supply of STB 20 enters from an ON state from an OFF state or at other specified timings.

(19) In the exemplary embodiment, the modified example 1 and the modified example 2, a case where reduced video image group SDV includes reduced video images of a plurality of first services and a plurality of second services has been described. However, reduced video image group SDV may not include reduced video images of the first services.

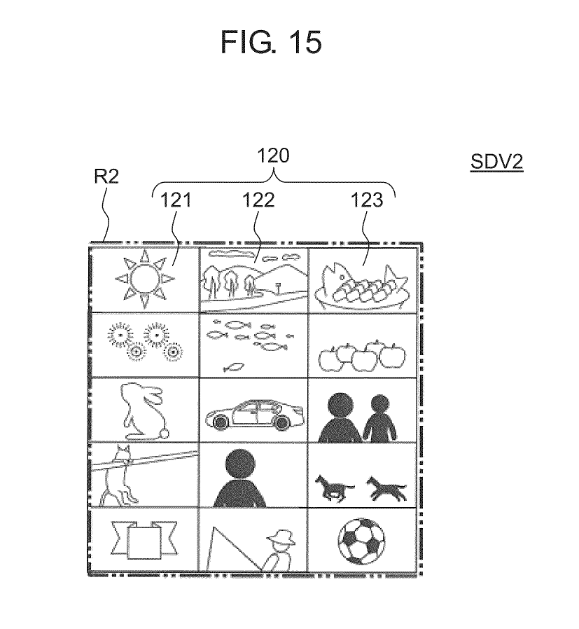

FIG. 15 is a diagram illustrating an example of reduced video image group SDV2 including reduced video images of a plurality of second services.

In this case, for example, controller 21 decodes a broadcast wave to a video image of the first service by using the tuner of broadcast wave receiver 23, performs reduction processing on the video image, and generates the reduced video image of the first service.

(20) In the exemplary embodiment, the modified example 1 and the modified example 2, controller 21 executes mask processing of generating a synthesized video image obtained by synthesizing template video image 31c and reduced video image group SDV, and synthesizing icon video images with the synthesized video image. However, the present disclosure is not limited to this.

Controller 21 may clip a reduced video image to display, from the reduced video image group, and synthesize the clipped reduced video image and template video image 31c.

The exemplary embodiments have been described above as the exemplary technique of the present disclosure. The accompanying drawings and the detailed description have been provided to describe the exemplary embodiments.

Hence, the components illustrated in the accompanying drawings and the detailed description may include not only essential components but also non-essential components in order to illustrate the above technique. Therefore it should be understood that the accompanying drawings and the detailed description of non-essential components do not immediately mean that those non-essential components are essential.

Further, the above exemplary embodiments are to illustrate the technique of the present disclosure, and therefore various modifications, replacements, additions, and omission can be made within the scope of the claims or equivalents of the claims.

What is claimed is:

1. A video image receiving apparatus comprising:
a video processor which outputs to a video image displaying apparatus a video image of a selection service for allowing selection of one service from a plurality of services including a plurality of first services and a plurality of second services,
wherein the video image of the selection service includes:
a plurality of first display regions where a plurality of first reduced video images are displayed, the first reduced video images being obtained by reducing video images of the plurality of first services;
a plurality of second display regions where a plurality of second reduced video images are displayed, the second reduced video images being obtained by reducing video images of the plurality of second services; and
a cursor which points to one display region of the plurality of first display regions and the plurality of second display regions,
wherein the video processor outputs to the video image displaying apparatus:
when the cursor points to one of the plurality of first display regions, a video image of a first selection service which displays a first reduced video image corresponding to a first display region pointed by the cursor in the first display region, and displays an icon video image for hiding the first reduced video image or the second reduced video image in each of the other first display regions except for the first display region and the plurality of second display regions; and
when the cursor points to one of the plurality of second display regions, a video image of a second selection service which displays a second reduced video image corresponding to a second display region in each of the plurality of second display regions, and displays the icon video image in each of the plurality of first display regions.

2. The video image receiving apparatus according to claim 1, wherein
each of the plurality of first services is a service whose reduced video image is not permitted to be simultaneously displayed on one screen together with reduced video images of the plurality of other services, and
each of the plurality of second services is a service which is permitted to be simultaneously displayed.

3. The video image receiving apparatus according to claim 1, further comprising a service receiver which receives from an external apparatus a reduced video image group including the plurality of first reduced video images and the plurality of second reduced video images.

4. The video image receiving apparatus according to claim 3, wherein
the video processor
obtains a template video image including the plurality of first display regions and the plurality of second display regions,
generates the video image of the first selection service by synthesizing, with the template video image, the first reduced video image corresponding to the first display region pointed by the cursor, and synthesizing the icon video image in each of the other first display regions except for the first display region pointed by the cursor and the plurality of second display regions, and
generates the video image of the second selection service by synthesizing, with the template video image, the second reduced video image corresponding to each of the plurality of second display regions, and synthesizing the icon video image with each of the plurality of first display regions.

5. The video image receiving apparatus according to claim 1, wherein the icon video image is a video image which uses a figure, a character or both of the figure and the character which indicate a corresponding service of the plurality of services.

6. The video image receiving apparatus according to claim 1, wherein
the selection service includes a multiplexed audio obtained by multiplexing a plurality of audios of the plurality of services, and
the video processor extracts, from the multiplexed audio, an audio of a service pointed by the cursor among the plurality of services, and outputs the extracted audio to the video image displaying apparatus.

7. The video image receiving apparatus according to claim 6, wherein, when receiving a movement request for the cursor while the video image displaying apparatus displays the video image of the first selection service or the video image of the second selection service, the video processor further moves the cursor, and specifies a service pointed by the cursor which has been moved and switches an audio to output to the video image displaying apparatus, from the audio of the service pointed by the cursor which has not been moved yet, to an audio of the service pointed by the cursor which has been moved.

8. The video image receiving apparatus according to claim 3, wherein the video processor further obtains specification information indicating in which display region of a plurality of display regions including the plurality of first display regions and the plurality of second display regions a reduced video image of each of the plurality of services is displayed, and when the video image of the first selection service or a video image of the second selection service is displayed, specifies a service displayed at a position of the cursor by using the specification information.

9. The video image receiving apparatus according to claim 1, wherein the video processor further obtains subscription information indicating whether each of one or more subscription required services which needs to be subscribed for viewing among a plurality of services is subscribed or unsubscribed, and synthesizes, with the video image of the first selection service and the video image of the second selection service, a video image indicating that a subscription required service is unsubscribed in a first display region or a second display region corresponding to the subscription required service whose unsubscription is indicated by the subscription information.

10. The video image receiving apparatus according to claim 9, wherein the video processor further records the video image of the first selection service and the video image of the second selection service with which the video image indicating the unsubscription is synthesized when recording the selection service.

11. A video image receiving method which is executed by a video processor which outputs to a video image displaying apparatus a selection service for allowing selection of one service from a plurality of services including a plurality of first services and a plurality of second services, wherein
the video image of the selection service includes:
a plurality of first display regions where a plurality of first reduced video images are displayed, the first reduced video images being obtained by reducing video images of the plurality of first services;
a plurality of second display regions where a plurality of second reduced video images are displayed, the second reduced video images being obtained by reducing video images of the plurality of second services; and
a cursor which points to one display region of the plurality of first display regions and the plurality of second display regions,
the video image receiving method comprising:
outputting to the video image displaying apparatus, when the cursor points to one of the plurality of first display regions, a video image of a first selection service which displays a first reduced video image corresponding to a first display region pointed by the cursor in the first display region, and displays an icon video image indicating a corresponding service in each of other display regions except for the first display region and the plurality of second display regions; and
outputting to the video image displaying apparatus, when the cursor points to one of the plurality of second display regions, a video image of a second selection service which displays a second reduced video image corresponding to a second display region in each of the plurality of second display regions, and displays the icon video image indicating a corresponding first service in each of the plurality of first display regions.
